(19) United States
(12) Patent Application Publication
(10) Pub. No.: US 2025/0386294 A1
(43) Pub. Date: Dec. 18, 2025

(54) NETWORK ENERGY SAVINGS

(71) Applicant: QUALCOMM Incorporated, San Diego, CA (US)

(72) Inventors: Kangqi LIU, San Diego, CA (US); Le LIU, San Jose, CA (US); Gabi SARKIS, San Diego, CA (US); Weimin DUAN, San Diego, CA (US)

(21) Appl. No.: 18/745,598

(22) Filed: Jun. 17, 2024

(51) Int. Cl. H04W 52/02

(52) U.S. Cl. CPC H04W 52/0235

(57) ABSTRACT

Methods, systems, and devices for wireless communications are described. In some examples, a user equipment (UE) may receive, via a first radio, a first signal that indicates one or more resource occasions for transmission of a wake-up signal (WUS). Based on receiving the first signal, the UE may transmit, via a second radio for the UE and via the indicated resource occasions, the WUS, where the WUS indicates for the network entity to operate according to a first mode of operation associated with higher power consumption relative to a second mode of operation. In such examples, the first radio of the UE may be associated with lower power consumption relative to the second radio of the UE. Based on transmitting the WUS, the UE may monitor, via the second radio, for control signaling and communicate with the network entity.

### FIELD OF TECHNOLOGY

The following relates to wireless communications, including network energy savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving, via a first radio of the UE, a first signal that indicates one or more resource occasions for transmission of a first wake-up signal (WUS), transmitting, via a second radio of the UE and the one or more resource occasions, the first WUS, where the first WUS indicates for a network entity to operate according to a first mode of operation, where the first mode of operation is associated with higher power consumption relative to a second mode of operation, and monitoring, via the second radio, for control signaling based on the transmission of the first WUS.

A UE for wireless communication is described. The UE may include one or more memories storing processor executable code, and one or more processors coupled with the one or more memories. The one or more processors may individually or collectively be operable to execute the code to cause the UE to receive, via a first radio of the UE, a first signal that indicates one or more resource occasions for transmission of a first WUS, transmit, via a second radio of the UE and the one or more resource occasions, the first WUS, where the first WUS indicates for a network entity to operate according to a first mode of operation, where the first mode of operation is associated with higher power consumption relative to a second mode of operation, and monitor, via the second radio, for control signaling based on the transmission of the first WUS.

Another UE for wireless communication is described. The UE may include means for receiving, via a first radio of the UE, a first signal that indicates one or more resource occasions for transmission of a first WUS, means for transmitting, via a second radio of the UE and the one or more resource occasions, the first WUS, where the first WUS indicates for a network entity to operate according to a first mode of operation, where the first mode of operation is associated with higher power consumption relative to a second mode of operation, and means for monitoring, via the second radio, for control signaling based on the transmission of the first WUS.

A non-transitory computer-readable medium storing code for wireless communication is described. The code may include instructions executable by one or more processors to receive, via a first radio of the UE, a first signal that indicates one or more resource occasions for transmission of a first WUS, transmit, via a second radio of the UE and the one or more resource occasions, the first WUS, where the first WUS indicates for a network entity to operate according to a first mode of operation, where the first mode of operation is associated with higher power consumption relative to a second mode of operation, and monitor, via the second radio, for control signaling based on the transmission of the first WUS.

Some examples of the method, UEs, and non-transitory computer-readable medium described herein may further include operations, features, means, or instructions for receiving, via the first radio and based on the transmission of the first WUS, a second WUS that indicates for the UE to operate via the first radio, where the control signaling may be monitored further based on reception of the second WUS.

Some examples of the method, UEs, and non-transitory computer-readable medium described herein may further include operations, features, means, or instructions for receiving, via the first radio of the UE, a second signal that indicates whether the network entity may be operating according to the first mode of operation or the second mode of operation.

In some examples of the method, UEs, and non-transitory computer-readable medium described herein, the second signal includes a first sequence that indicates that the network entity may be operating according to the first mode of operation.

In some examples of the method, UEs, and non-transitory computer-readable medium described herein, the second signal includes a second sequence that indicates that the network entity may be operating according to the second mode of operation.

In some examples of the method, UEs, and non-transitory computer-readable medium described herein, the second signal includes a low power synchronization signal (LP-SS) and the control signaling includes a synchronization signal block (SSB), and the control signaling may be monitored in accordance with a time offset between a resource of the second signal and a resource of the control signaling.

In some examples of the method, UEs, and non-transitory computer-readable medium described herein, a periodicity of the second signal may be equivalent to a periodicity of the control signaling.

In some examples of the method, UEs, and non-transitory computer-readable medium described herein, a periodicity of the control signaling may be a multiple of a periodicity of the second signal or the periodicity of the second signal may be a multiple of the periodicity of the control signaling.

In some examples of the method, UEs, and non-transitory computer-readable medium described herein, the second signal may be a LP-SS and the first signal may be a low power system information block (LP-SIB), and the first signal may be received subsequent to the second signal according to a time offset.

In some examples of the method, UEs, and non-transitory computer-readable medium described herein, the second signal includes a second WUS and the first signal includes a LP-SIB.

In some examples of the method, UEs, and non-transitory computer-readable medium described herein, the first signal and the second signal include a LP-SIB.

In some examples of the method, UEs, and non-transitory computer-readable medium described herein, the first radio of the UE may be associated with lower power consumption relative to the second radio of the UE.

In some examples of the method, UEs, and non-transitory computer-readable medium described herein, the first WUS includes an on-off keying waveform, a frequency-shift keying waveform, or a frequency-modulated continuous wave waveform.

In some examples of the method, UEs, and non-transitory computer-readable medium described herein, the first signal includes an on-off keying waveform, a frequency-shift keying waveform, or a frequency-modulated continuous wave waveform.

A method for wireless communication by a network entity is described. The method may include transmitting, via a first radio of the network entity, a first signal that indicates one or more resource occasions for a first WUS, receiving, via a second radio of the network entity and the one or more resource occasions, the first WUS, where the first WUS indicates for the network entity to operate according to a first mode of operation, where the first mode of operation is associated with higher power consumption relative to a second mode of operation, and transmitting, via the first radio, control signaling based on the reception of the first WUS.

A network entity for wireless communication is described. The network entity may include one or more memories storing processor executable code, and one or more processors coupled with the one or more memories. The one or more processors may individually or collectively be operable to execute the code to cause the network entity to transmit, via a first radio of the network entity, a first signal that indicates one or more resource occasions for a first WUS, receive, via a second radio of the network entity and the one or more resource occasions, the first WUS, where the first WUS indicates for the network entity to operate according to a first mode of operation, where the first mode of operation is associated with higher power consumption relative to a second mode of operation, and transmit, via the first radio, control signaling based on the reception of the first WUS.

Another network entity for wireless communication is described. The network entity may include means for transmitting, via a first radio of the network entity, a first signal that indicates one or more resource occasions for a first WUS, means for receiving, via a second radio of the network entity and the one or more resource occasions, the first WUS, where the first WUS indicates for the network entity to operate according to a first mode of operation, where the first mode of operation is associated with higher power consumption relative to a second mode of operation, and means for transmitting, via the first radio, control signaling based on the reception of the first WUS.

A non-transitory computer-readable medium storing code for wireless communication is described. The code may include instructions executable by one or more processors to transmit, via a first radio of the network entity, a first signal that indicates one or more resource occasions for a first WUS, receive, via a second radio of the network entity and the one or more resource occasions, the first WUS, where the first WUS indicates for the network entity to operate according to a first mode of operation, where the first mode of operation is associated with higher power consumption relative to a second mode of operation, and transmit, via the first radio, control signaling based on the reception of the first WUS.

Some examples of the method, network entities, and non-transitory computer-readable medium described herein may further include operations, features, means, or instructions for transmitting, via the first radio and based on reception of the first WUS, a second WUS that indicates an acknowledgement of the first WUS, where the control signaling may be transmit based on transmission of the second WUS.

Some examples of the method, network entities, and non-transitory computer-readable medium described herein may further include operations, features, means, or instructions for transmitting, via the first radio, a second signal that indicates whether the network entity may be operating according to the first mode of operation or the second mode of operation.

In some examples of the method, network entities, and non-transitory computer-readable medium described herein, the second signal includes a first sequence that indicates that the network entity may be operating according to the first mode of operation.

In some examples of the method, network entities, and non-transitory computer-readable medium described herein, the second signal includes a second sequence that indicates that the network entity may be operating according to the second mode of operation.

In some examples of the method, network entities, and non-transitory computer-readable medium described herein, the transmission of the second signal may be based on a determination that there may be no active UEs communicating with the network entity.

In some examples of the method, network entities, and non-transitory computer-readable medium described herein, the second signal includes a LP-SS and the control signaling includes a SSB, and the control signaling may be transmitted in accordance with a time offset between a resource of the second signal and a resource of the control signaling.

In some examples of the method, network entities, and non-transitory computer-readable medium described herein, a periodicity of the second signal may be equivalent to a periodicity of the control signaling.

In some examples of the method, network entities, and non-transitory computer-readable medium described herein, a periodicity of the control signaling may be a multiple of a periodicity of the first signal or the periodicity of the first signal may be a multiple of the periodicity of the control signaling.

In some examples of the method, network entities, and non-transitory computer-readable medium described herein, the second signal may be a LP-SS and the first signal may be a LP-SIB, and the first signal may be transmitted subsequent to the second signal according to a time offset.

In some examples of the method, network entities, and non-transitory computer-readable medium described herein, the second signal includes a second WUS and the first signal includes a LP-SIB.

In some examples of the method, network entities, and non-transitory computer-readable medium described herein, the first signal and the second signal include a LP-SIB.

In some examples of the method, network entities, and non-transitory computer-readable medium described herein, the first radio of the network entity may be associated with the first mode of operation and the second radio of the network entity may be associated with the second mode of operation.

In some examples of the method, network entities, and non-transitory computer-readable medium described herein, the first WUS includes an on-off keying waveform, a frequency-shift keying waveform, or a frequency-modulated continuous wave waveform.

In some examples of the method, network entities, and non-transitory computer-readable medium described herein, the first signal includes an on-off keying waveform, a frequency-shift keying waveform, or a frequency-modulated continuous wave waveform.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support network energy savings in accordance with one or more aspects of the present disclosure.

FIG. 3 shows an example of a flow diagram that supports network energy savings in accordance with one or more aspects of the present disclosure.

FIG. 4 shows an example of a flow diagram that supports network energy savings in accordance with one or more aspects of the present disclosure.

FIGS. 5A and 5B show examples of timing diagrams that support network energy savings in accordance with one or more aspects of the present disclosure.

FIG. 6 shows an example of a process flow that supports network energy savings in accordance with one or more aspects of the present disclosure.

FIGS. 7 and 8 show block diagrams of devices that support network energy savings in accordance with one or more aspects of the present disclosure.

FIG. 9 shows a block diagram of a communications manager that supports network energy savings in accordance with one or more aspects of the present disclosure.

FIG. 10 shows a diagram of a system including a device that supports network energy savings in accordance with one or more aspects of the present disclosure.

FIGS. 11 and 12 show block diagrams of devices that support network energy savings in accordance with one or more aspects of the present disclosure.

FIG. 13 shows a block diagram of a communications manager that supports network energy savings in accordance with one or more aspects of the present disclosure.

FIG. 14 shows a diagram of a system including a device that supports network energy savings in accordance with one or more aspects of the present disclosure.

FIGS. 15 through 18 show flowcharts illustrating methods that support network energy savings in accordance with one or more aspects of the present disclosure.

### DETAILED DESCRIPTION

In some wireless communications systems, a network entity may operate in a low power mode, such that the network entity may save energy (e.g., the wireless communications system may support network energy savings). To facilitate such a low power mode, the network entity may implement a low power wake-up radio (LP-WUR), where, while operating in the low power mode, the network entity may maintain a main radio of the network entity in a deep sleep state and utilize the LP-WUR for communications. By maintaining the main radio in the deep sleep state, the network entity may experience increased power savings, thereby supporting network energy savings. In such examples, however, the implementation of the LP-WUR at a network entity may lead to various procedures between the network entity and one or more user equipments (UEs) served by the network entity being inoperable. Accordingly, implementation of the LP-WUR at the network entity may fail without a mechanism to support some wireless signaling and communication with one or more additional devices.

The techniques described herein may provide for signaling and procedures between a UE and the network entity to support the implementation of the LP-WUR at the network entity. For example, the network entity may determine that there are no active UEs in a coverage area of the network entity and may enter the low power mode based on the determination. Prior to entering the low power mode, the network entity may transmit, to the UE, a first signal (e.g., a low power signal) indicating one or more resource occasions for transmission of a first wake-up signal (WUS). Accordingly, during the low power mode, the network entity may utilize the LP-WUR to monitor for the first WUS from the UE. If the UE determines to resume or begin active communications with the network entity, the UE may transmit the first WUS to the network entity via the indicated resource occasions, where the first WUS may indicate for the network entity to wake-up the main radio and operate according to an active mode of operation. Based on receiving the first WUS, the network entity may transmit control signaling (e.g., a synchronization signal block (SSB) or system information blocks (SIBs)) to enable active communications (e.g., communications while operating in an active mode of operation) between the UE and the network entity. By implementing the aforementioned signaling and procedures, the network entity may utilize the LP-WUR to reduce power consumption at the network entity, while maintaining communications with the UE.

Aspects of the disclosure are initially described in the context of wireless communications systems, flow diagrams, timing diagrams, and process flows. Aspects of the disclosure are further illustrated by and described with reference to apparatus diagrams, system diagrams, and flowcharts that relate to network energy savings.

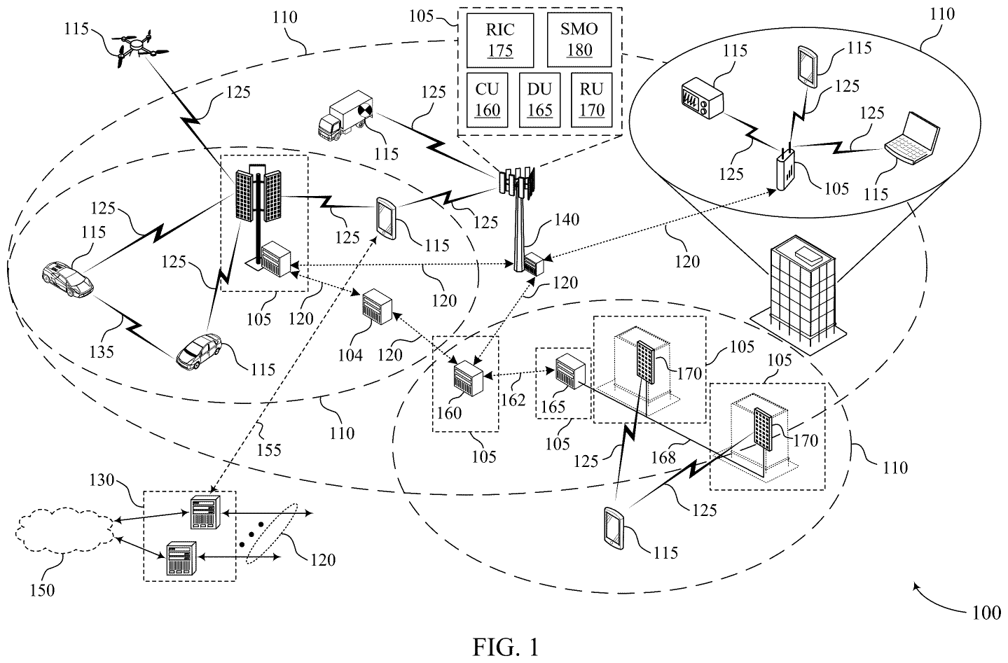

FIG. 1 shows an example of a wireless communications system 100 that supports network energy savings in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless devices (e.g., UEs 115, network entities 105) may use multiple types of radios for communication. For example, a wireless device may implement a main radio and a LP-WUR, where the wireless device may utilize the main radio during active communications (e.g., communications while operating in a connected mode, such as an RRC_CONNECTED mode) and may utilize a LP-WUR during inactive communications (e.g., communications while operating in a sleep or idle mode, such as RRC_INACTIVE or RRC_IDLE modes). In such examples, the LP-WUR may be a receive-only radio and act as a companion receiver to the main radio in each device. Accordingly, the wireless device may utilize the LP-WUR to monitor for, and receive, low power signals (e.g., WUSs, low power synchronization signals (LP-SS), among other examples), while maintaining the main radio in a deep sleep state. Based on receiving a WUS, the LP-WUR may wake-up (e.g., activate) the main radio, such that active communications may resume at the wireless device.

In such implementations, the LP-WUR may be designed to consume less power than the main radio. For example, the LP-WUR may be powered separately and, additionally, or alternatively, may use blocks that use less power (e.g., less power hungry blocks). In this way, a wireless device using the LP-WUR may reduce total power consumption by avoiding unnecessary wake up of the main radio, which may have high power consumption. Additionally, or alternatively, the wireless device may experience a reduction in latency using the LP-WUR by monitoring for a WUS relatively frequently.

As an illustrative example, the UE 115 may include an LP-WUR (also referred to as a UE wake-up radio (UE-WUR)) and a main radio, such that the UE may utilize the LP-WUR while operating in a low power mode and utilize the main radio for communications while operating in an active mode. For example, while the UE 115 operates within the low power mode, the UE 115 may monitor for one or more low power signals, such as LP-SSs or WUSs, from the network entity that may be received at the UE 115 via the UE-WUR. In such examples, to wake-up the UE 115 from the low power mode, the network entity 105 may transmit a WUS. In some examples, the network entity 105 may transmit the WUS according to a periodicity. In some cases, the UE 115 may monitor for the WUS if the UE 115 has a message for the network entity 105 (e.g., msg1, physical random access channel (PRACH) procedure message). In some cases, the network entity 105 may delay transmitting the WUS, such as until the network entity has a transmission for the UE 115.

Based on receiving the WUS, the UE 115 may wake-up (e.g., activate) the main radio of the UE to receive paging message and resume or begin active communications with the network entity 105. For example, in response to receiving the WUS, the UE 115 may activate the main radio and proceed to monitor for a paging message from the network entity 105. Based on receiving the paging message, the UE 115 may utilize one or more resource occasions indicated within the paging message to monitor for and receive control signaling, such as an SSB and a SIB1. Based on receiving the control signaling, the UE 115 may transmit a message to the network entity 105, such as a PRACH message (e.g., msg1), to gain access to the network entity. Alternatively, in response to receiving the control signaling, the UE 115 may resume active communications with the network entity.

In some examples, the UE 115 and the network entity 105 may support on-demand SSB transmissions, support on-demand SIB1 transmissions, support SSB adaptation, support PRACH adaptation, support paging adaptation, support enhanced spatial adaptation, support enhanced discontinuous transmission (DTX), support enhanced discontinuous reception (DRX), or any combination thereof.

For example, the UE 115 and the network entity 105 may implement procedures and signaling methods to support on-demand SSB serving cell operations for UEs in connected mode (e.g., RRC connected mode) that are configured with carrier aggregation (e.g., via RRC signaling), where such on-demand SSB operations may be utilized in both intra-band and inter-band carrier aggregation. For example, the UE 115 may trigger the on-demand SSB transmission by transmitting an uplink WUS to the network entity 105 using an existing signal, channel, or both. Alternatively, the on-demand SSB may be triggered by communication of a cell-on or cell-off indication via a backhaul communication link, by communication of serving cell activation or deactivation signaling, or a combination thereof. In some cases, the UE 115 may utilize on-demand SSB transmissions for time or frequency synchronization with the serving cell, layer 1 (L1) or layer 3 (L3) measurements, serving cell activation, or a combination thereof. In such examples, the UE 115 and the network entity 105 may support on-demand SSB transmissions for communications via the frequency band 1 (FR1) and frequency band 2 (FR2) communication in a non-shared spectrum.

Additionally, or alternatively, the UE 115 and the network entity 105 may implement procedures and signaling methods to support on-demand SIB1 transmissions for UEs 115 operating in the inactive or idle modes. For example, the UE 115 may trigger the on-demand SIB1 transmission by transmitting an uplink WUS via an existing signal, via an existing channel, or both. In such examples, the UE 115 may be provisioned (e.g., by the network entity 105 or other means) with a configuration associated with the WUS, where the UE 115 may transmit the WUS according to the provisioned configuration. In some implementations, one or more network entities 105 may communication (e.g., exchange information) to determine the configuration of the WUSs.

The UE 115 and the network entity 105 may implement techniques to adapt the SSB in the time domain, for example, by adapting the periodicity with which the SSB is transmitted. Similarly, the UE 115 and the network entity 105 may implement techniques to adapt PRACH transmissions in the time domain, the spatial domain, or both. For example, the UE 115 and the network entity 105 may adapt the PRACH transmission in the spatial domain, such as by using non-uniform PRACH resources for an SSB. Additionally, or alternatively, the UE 115 and the network entity 105 may implement techniques to adapt paging occasions, such as by confining the paging occasions in the time domain. Such adaptation may not lead to an increase in the latency associated with paging and may or may not impact legacy devices.

As described herein, it may be desirable for the network entity 105 to operate in a low power mode, such that the network entity 105 may save energy (e.g., support network energy savings). To facilitate such a low power mode, the network entity 105 may implement a LP-WUR, where, while operating in the low power mode, the network entity 105 may maintain a main radio of the network entity 105 in a deep sleep state and utilize the LP-WUR for communications. By maintaining the main radio in the deep sleep state, the network entity 105 may experience increased power savings, thereby supporting network energy savings. In such examples, however, the implementation of the LP-WUR at a network entity 105 may lead to various procedures between the network entity 105 and one or more UEs 115 served by the network entity 105 being inoperable. Accordingly, various signals and procedures may be desired to support the implementation of the LP-WUR at the network entity 105.

The techniques described herein may provide for signaling and procedures between the UE 115 and the network entity 105 to support the implementation of the LP-WUR at the network entity 105. For example, the network entity 105 may determine that there are no active UEs 115 in a coverage area of the network entity 105, that the UE 115 within the coverage area of the network entity 105 is operating in a low power mode, or both, and may enter the low power mode based on the determination. Prior to entering the low power mode, the network entity 105 may transmit, to the UE 115, a first signal (e.g., a low power signal) indicating one or more resource occasions for transmission of a first WUS. Accordingly, during the low power mode, the network entity 105 may utilize the LP-WUR to monitor for the first WUS from the UE 115. If the UE 115 determines to resume or begin active communications with the network entity 105, the UE 115 may transmit the first WUS to the network entity 105 via the indicated resource occasions, where the WUS may indicate for the network entity 105 to wake-up the main radio of the network entity 105 and operate according to an active mode of operation. Based on receiving the first WUS, the network entity 105 may transmit control signaling to enable active communications (e.g., communications while operating in an active mode of operation) between the UE 115 and the network entity 105. By implementing the aforementioned signaling and procedures, the network entity 105 may utilize the LP-WUR to reduce power consumption at the network entity 105, while maintaining communications with the UE 115.

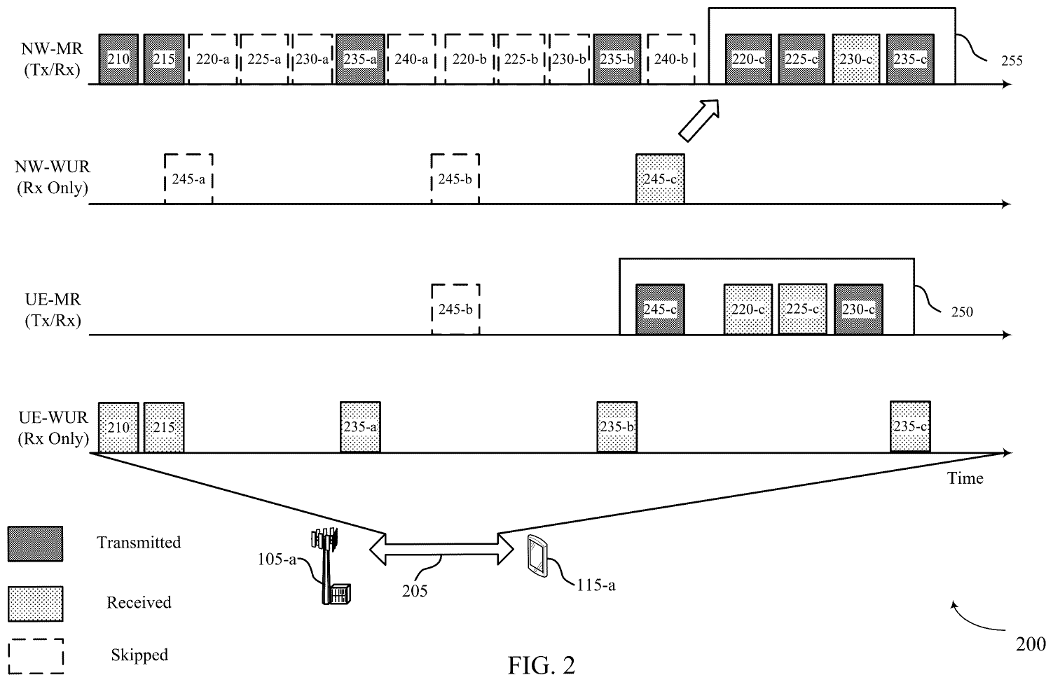

FIG. 2 shows an example of a wireless communications system 200 that supports network energy savings in accordance with one or more aspects of the present disclosure. In some examples, aspects of the wireless communications system 200 may implement, or be implemented by, aspects of the wireless communications system 100. For example, the wireless communications system 200 may include a UE 115-a and a network entity 105-a, which may be examples of the corresponding devices as described herein, including with reference to FIG. 1. The techniques described in the context of the wireless communications system 200 may provide signaling techniques that support the implementation of a low power WUR at the network entity 105-a (also referred to as a network entity wake-up radio (NW-WUR)).

In some wireless communication systems, the network entity 105-a and the UE 115-a may communicate via a communication link 205. To support energy savings at the UE 115-a, the UE 115-a may include and use a low power WUR (e.g., UE-WUR, first radio of the UE). In such examples, the UE-WUR may be separate from a main radio of the UE (e.g., UE main radio (UE-MR), second radio of the UE) and be associated with lower power consumption relative to the UE-MR. Additionally, to facilitate network energy savings, the network entity 105-a may include the NW-WUR (e.g., second radio at the network entity), which may be separate from a main radio of the network entity 105 (e.g., network entity main radio (NW-MR), first radio at the network entity) and may be associated with relatively less power consumption than the NW-MR.

As described herein, the UE 115-a and the network entity 105-a may implement one or more signals, signaling procedures, or both to support the implementation of the NW-MR at the network entity 105-a, thereby enabling the network entity 105-a to benefit from network energy savings.

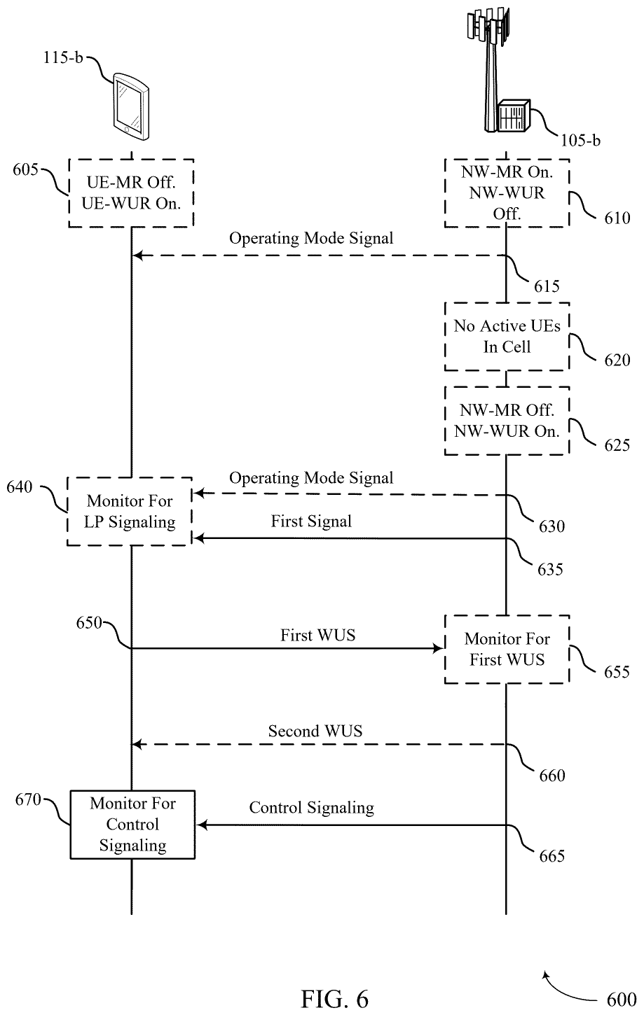

For example, the network entity 105-a and the UE 115-a may support a low power SIB 215 (LP-SIB 215), a WUS 245 (e.g., message 1-WUS, uplink WUS, first WUS), or both to enable the use of NW-WUR at the network entity 105-a, where such signals and waveform considerations for such signals may be further described herein with reference to FIGS. 2 and 6. The network entity 105-a and the UE 115-a may also support signaling and procedures for mode transitions (e.g., state transitions) by the network entity 105-a, for example, transitions from an active mode (e.g., NW-MR on and NW-WUR off) to a low power mode (e.g., NW-MR off and NW-WUR on), or vice versa. Techniques to support state transitions by the network entity may be further described herein with reference to FIGS. 2 and 6.

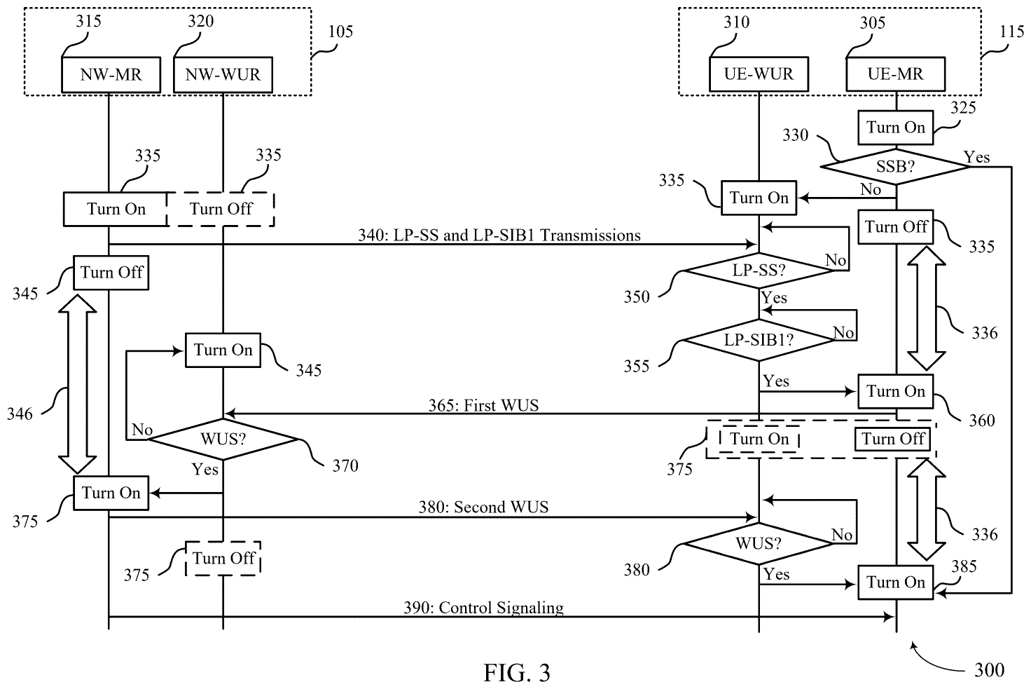

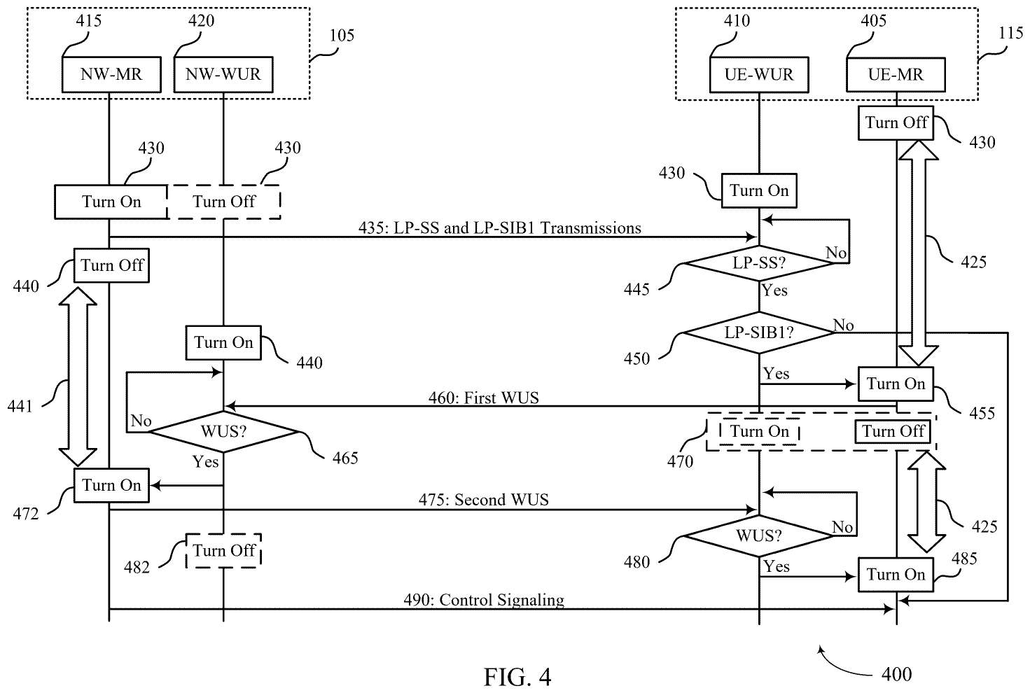

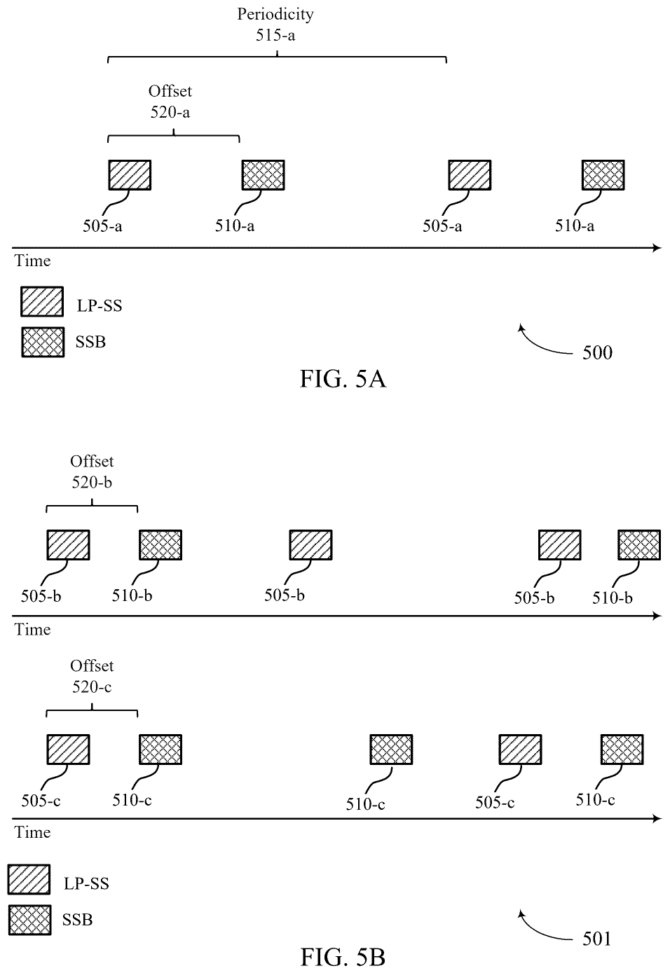

Additionally, the network entity 105-a and the UE 115-a may implement signaling and procedures for initial access by a UE 115 to the network entity 105-a having a NW-WUR, where such techniques may be further described herein with reference to FIGS. 3 and 4. To support the network energy savings at the network entity 105-a, the network entity 105-a and the UE 115-a may define an association between a LP-SS 210 and SSB 220 occasion, which may be further described herein with reference to FIG. 5. Accordingly, by implementing such techniques, the network entity 105-a may implement the NW-WUR, which may enable the network entity 105-a to achieve network energy savings.

As described herein, the network entity 105-a may enter a low power mode of operation. In some examples, the network entity 105-a may enter the low power mode if there are no active UEs 115 in a cell of the network entity 105-a. For example, during various time periods of the day (e.g., at night or during traditionally inactive periods) or based on a location of the network entity 105-a (e.g., in rural areas, activity within the cell may be relatively low), the network entity 105-a determine that the network entity 105-a is not serving any active UEs 115. Accordingly, based on such a determination, the network entity 105-a may enter the low power mode.

To enter the low power mode, the network entity 105-a may turn off (e.g., deactivate or place in a deep sleep state) the NW-MR, except for transmitting various low power signals, such as the LP-SS 210, the LP-SIB 215, the WUS 235, or a combination thereof. Based on turning off the NW-MR, the network entity may turn on (e.g., activate) the NW-WUR to monitor for the WUS 245 from the UE 115-a. Accordingly, while operating in the low power mode, the network entity 105-a may refrain from transmitting SSBs 220, SIBs 225 (e.g., SIB1 messages), and refrain from monitoring random access channel (RACH) occasions 230 for a message 1 transmission. For example, the network entity 105-a may deactivate the NW-MR and refrain from transmitting (e.g., skip) SSBs 220-a and 220-b, refrain from transmitting SIBs 225-a and 225-b, and refrain from monitoring the RACH occasions 230-a and 230-b. Similarly, during the low power mode, the network entity 105-a may refrain from transmitting paging messages 240-a and 240-b. In this way, the network entity 105-a may experience power savings while operating in the low power mode.

In some examples, based on determining to enter the low power mode, the network entity 105-a may transmit the LP-SS 210, the LP-SIB 215, the WUS 235-a, or a combination thereof, to the UE 115-a. In such examples, the LP-SIB 215 may be transmitted when the network entity 105-a turns off the NW-MR (except for LP-SS 210 and/or LP-SIB 215 transmission) and may turn on the NW-WUR. When the NW-main radio is on (e.g., the network entity 105-a is operating according to the active mode), the LP-SIB 215 may not be transmitted.

As described herein, the network entity 105-a may transmit the LP-SS 210 and the LP-SIB 215 according to a timing offset. For example, the network entity 105-a may transmit the LP-SS 210 at a first time and transmit the LP-SIB 215 at a second time, where a difference between the second time and the first time is according to the timing offset. Such a timing offset may be predefined (e.g., in a wireless communications standard) or signaled to the UE 115-a prior to the network entity 105-a entering the low power mode. In such examples, the UE 115-a may monitor for and receive the LP-SS 210 and the LP-SIB 215 using the UE-WUR.

In some examples, the network entity 105-a may use the LP-SIB 215 to indicate one or more resource occasions for transmission of the WUS 245, such as occasions for a WUS 245-a, a WUS 245-b, and a WUS 245-c, where the WUS 245 may be used by the UE 115-a to indicate the network entity 105-a to wake-up the NW-MR and resume or begin SSB 220 transmissions, resume or begin SIB 225 transmissions, and resume or begin monitoring the RACH occasions 230.

Accordingly, because the UE 115-a may transmit the WUS 245-c to resume or begin active communications with the network entity 105-a, the UE 115-a may not monitor and decode the LP-SIB 215 until the UE 115-a may have one or more messages to communicate with the network entity 105-a. That is, the UE 115-a may not monitor and decode the LP-SIB 215 at the earliest time of LP-SIB 215 transmission and may wait until the UE 115-a may have to wake-up the network entity 105-a to send control signaling (e.g., SSB 220, SIB 225), to monitor the RACH occasions 230, or both.

In some implementations, the network entity 105-a may transmit one or more low power signals to indicate the current mode of operation (e.g., low power or active) of the network entity 105-b. For example, the network entity 105-a may use the LP-SS 210, the LP-SIB 215, or the WUSs 235 to indicate to the UE 115-a that the network entity 105-a is transitioning into the low power mode (e.g., NW-main radio off and NW-WUR on, low power state).

For example, the network entity 105-a may transmit the LP-SS 210 using the NW-MR, which may be received at the UE 115-a using the UE-WUR. The LP-SS 210 may implicitly indicate the operating mode of the network entity 105-a. For example, the LP-SS 210 may include two sequences that implicitly indicate the operating mode of the network entity 105-a. If the network entity 105-a transmits the LP-SS 210 according to a first sequence, the UE 115-a may determine that the NW-MR is on (e.g., the network entity 105-a may be operating in an active power mode). In such cases, if the UE 115-a is operating in the low power mode and receives the LP-SS 210 with the first sequence, the UE 115-a may wake-up the UE-ME to monitor for and receive an SSB 220, monitor for and receive a SIB 225, perform RACH to gain access to the network entity 105-a, or a combination thereof.

Alternatively, if the network entity 105-a transmits the LP-SS 210 according to a second sequence, the UE 115-a may determine that the NW-MR is off (e.g., the network entity 105-a may be operating in a low power mode). In such cases, to resume or begin communications with the network entity 105-a, the UE 115-a may transmit the WUS 245 to wake up the NW-MR, such that the network entity 105-a may begin or resume SSB 220 transmissions, begin or resume SIB 225 transmission, begin or resume monitoring the RACH occasions 230, or a combination thereof.

In some other examples, to indicate the mode of operation (e.g., low power or active) of the network entity 105-a, the network entity 105-a may transmit a WUS 235 to the UE 115-a, such as the WUSs 235-a, 235-b, and 235-c. For example, WUSs 235 may indicate for the UE 115-a to begin monitoring for the LP-SIB 215, thereby implicitly indicating to the UE 115-a that the NW-MR is off and the network entity 105-a is to begin operating in the low power mode.

As an illustrative example of such signaling, the UE 115-a may operate in a low power mode. The network entity 105-a may determine that the UE 115-a is in the low power mode and determine that there are no active UEs 115 within the coverage area of the network entity 105-a. Accordingly, the network entity 105-a may transmit the LP-SS 210 (or the WUS 235) to indicate to the UE 115 that the network entity 105-a is to transition into the low power mode and operate according to the NW-WUR. Based on transmitting the LP-SS 210, the network entity 105-a may transmit the LP-SIB 215 (according to the fixed time offset from transmission of the LP-SS 210), where the LP-SIB 215 may indicate one or more resource occasions for transmission of the WUS 245.

As described herein, while operating in the low power mode, the network entity 105-a may turn off the NW-MR and may refrain from transmitting SSBs 220, refrain from transmitting SIBs 225, and refrain from monitoring RACH occasions 230. In some examples, the network entity 105-a may periodically wake-up the NW-MR to transmit a WUS 235, such as the WUSs 235-a and 235-b, indicating to the UE 115-a to continue monitoring for LP-SIBs 215 and implicitly indicating to the UE 115-a that the NW-MR is off.

Accordingly, the UE 115-a may skip one or more resource occasions for the WUS 245, such as skip the WUS 245-b transmission, until the UE 115-a has one or more messages to communicate with the network entity 105-a. That is, if the UE 115-a desires to transition into an active mode of operation 250, the UE 115-a may turn on the UE-MR and transmit the WUS 245-c via a resource occasion indicated by the LP-SIB 215. Accordingly, the network entity 105-a may monitor for and receive the WUS 245-c using the NW-WUR, where the WUS 245-c may indicate for the network entity 105-a to transition into an active mode of operation 255 and wake-up (e.g., activate or turn on) the NW-MR.

Accordingly, based on waking up the NW-MR, the network entity 105-a may transmit an SSB 220-c, transmit an SIB 225-c, monitor an RACH occasion 230-c, or a combination thereof, such that the UE 115-a and the network entity 105-a may begin, or resume, communications. In this way, by implementing the aforementioned signals and procedures, the network entity 105-a may implement the NW-WUR, thereby saving energy at the network entity 105-a.

FIG. 3 shows an example of a flow diagram 300 that supports network energy savings in accordance with one or more aspects of the present disclosure. The flow diagram 300 may implement, or be implemented to, realize aspects of the wireless communications system 100 and the wireless communications system 200. For example, the flow diagram 300 illustrates communication between a UE 115 and a network entity 105, which may be examples of corresponding devices described herein, including with reference to FIGS. 1 and 2. Additionally, as described herein with reference to FIG. 2, the UE 115 may include a UE-MR 305 and a UE-WUR 310, while the network entity 105 may include a NW-MR 315 and a NW-WUR 320. The techniques described in the context of the flow diagram 300 may enable the UE to perform an initial access procedure to gain access to the network entity 105.

At 325, the UE 115 may turn on the UE-MR 305. At 330, the UE 115 may monitor, using the UE-MR, for SSB transmissions. In such examples, if the UE 115 detects an SSB transmission at 330, the UE 115 may proceed to perform the operations described at 385 and 390. Alternatively, if the UE 115 does not detect an SSB transmission at 330, the UE 115 may proceed to perform the operations at 335.

At 335, the UE 115 may enter a low power mode by turning off (e.g., deactivate) the UE-MR 305 and activating the UE-WUR 310, such that the UE 115 may experience power savings 336. At 335, the network entity 105 may enter an active mode by turning on the NW-MR 315 to transmit one or more low power signals, such as LP-SSs, LP-SIBs, or both. In such examples, the network entity 105 may optionally turn off the NW-WUR 320.

At 340, the network entity 105 may transmit an LP-SS, an LP-SIB, or both to the UE 115. The network entity 105 may indicate, via the LP-SS, whether the network entity 105 is to operate according to the active mode or low power mode, as described herein with reference to FIG. 2. The network entity 105 may indicate, via the LP-SIB, one or more resource occasions for transmission of a first WUS (e.g., a WUS 245).

At 345, the network entity 105 may reenter the low power mode by turning off the NW-MR 315 and, optionally, turning on the NW-WUR 320. Accordingly, the network entity 105 may experience network energy savings 346 while operating in the low power mode (e.g., while the NW-MR 315 is off and the NW-WUR 320 is on). As such, the network entity 105 may monitor for the first WUS from the UE 115 using the NW-WUR 320 during the low power mode.

At 350 and 355, the UE 115 may monitor, using the UE-WUR 310, for the LP-SS and the LP-SIB. Accordingly, if the UE 115 does not detect either the LP-SS or the LP-SIB (e.g., the operations at 340 have not occurred yet), the UE 115 may maintain operating in the low power mode and continue to monitor for such signals. Alternatively, if the UE 115 does detect the LP-SS and the LP-SIB, the UE 115 may proceed to turn on the UE-MR at 360.

For example, at 360, if the UE 115 determines to gain access to the network entity 105 (e.g., due to having one or more messages to communicate with the network entity), the UE 115 may proceed to turn on the UE-MR 305. At 365, based on turning on the UE-MR 305, the UE 115 may, via the UE-MR 305, transmit the first WUS to the network entity 105, indicating for the network entity 105 to wake-up the NW-MR 315 and initiate the initial access procedure with the UE 115. Based on transmitting the first WUS, the UE 115 may proceed to perform the operations at 375. Accordingly, at 370, the network entity 105 may monitor for the first WUS from the UE 115, where, if the network entity 105 detects the first WUS, the network entity may proceed to perform the operations at 375. Alternatively, if the network entity 105 does not detect the first WUS at 370 (due to the transmission of the first WUS not occurring), the network entity 105 may continue to operate in the low power mode and monitor for the first WUS from the UE 115.

At 375, based on detecting the first WUS, the network entity 105 may turn on the NW-MR 315. Similarly, at 375, based on transmitting the first WUS, the UE 115 may turn off the UE-MR 305 and turn on the UE-WUR 310. Accordingly, at 380 and based on turning on the NW-MR 315, the network entity 105 may transmit a second WUS. Similarly, at 380, the UE 115 may monitor for the second WUS, where the second WUS may acknowledge the detection and reception of the first WUS at 370 and indicate that the NW-MR 315 is on and the network entity 105 is operating in the active mode. Additionally, the second WUS may trigger the UE to turn on the UE-MR 305 to receive paging indications, resume SSB and SIB1 transmission monitoring, or both. Accordingly, if the UE 115 does not detect the WUS at 380, indicating that the network entity 105 has yet to wake-up and transmit the second WUS, the UE 115 may continue to monitor for the second WUS at 380.

At 385, based on receiving the second WUS, the UE 115 may turn on the UE-MR 305 to perform SSB searching. For example, at 390, based on transmitting the second WUS, the network entity 105 may transmit control signaling (e.g., SSBs), such that the UE 115 may search for and receive the SSB, where the SSB may provide information to the UE 115 associated with gaining access to the network entity 105.

FIG. 4 shows an example of a flow diagram 400 that supports network energy savings in accordance with one or more aspects of the present disclosure. The flow diagram 400 may implement or be implemented to realize aspects of the wireless communications systems 100 or 200 and flow diagram 300. For example, the flow diagram 400 illustrates communication between a UE and a network entity, which may be examples of corresponding devices described herein, including with reference to FIGS. 1-4. The flow diagram 400 may provide for network energy savings through signaling between the network entity and the UE during an initial access operation for the UE.

At 430, the UE 115 may enter a low power mode by turning off (e.g., deactivate) the UE-MR 405 and activating the UE-WUR 410, such that the UE 115 may experience power savings (e.g., during the periods 425). Similarly, at 430, the network entity 105 may enter an active mode by turning on the NW-MR 415 to transmit one or more low power signals, such as LP-SSs, LP-SIBs, or both. In such examples, the network entity 105 may optionally turn off the NW-WUR 420.

At 435, the network entity 105 may transmit an LP-SS, an LP-SIB, or both to the UE 115. The network entity 105 may indicate, via the LP-SS, whether the network entity 105 is to operate according to the active mode or low power mode, as described herein with reference to FIG. 2. The network entity 105 may indicate, via the LP-SIB, one or more resource occasions for transmission of a first WUS (e.g., a WUS 245).

At 440, the network entity 105 may reenter the low power mode by turning off the NW-MR 415 and, optionally, turning on the NW-WUR 420. Accordingly, the network entity 105 may experience network energy savings (e.g., during the period 441) while operating in the low power mode (e.g., while the NW-MR 415 is off and the NW-WUR 420 is on). As such, the network entity 105 may monitor for the first WUS from the UE 115 using the NW-WUR 420 during the low power mode.

At 445 and 450, the UE 115 may monitor, using the UE-WUR 410, for the LP-SS and the LP-SIB. Accordingly, if the UE 115 does not detect either the LP-SS or the LP-SIB (e.g., the operations at 435 have not occurred yet), the UE 115 may maintain operating in the low power mode and continue to monitor for such signals. Alternatively, if the UE 115 does detect the LP-SS and the LP-SIB, the UE 115 may proceed turn on the UE-MR at 455.

For example, at 455, if the UE 115 determines to gain access to the network entity 105 (e.g., due to having one or more messages to communicate with the network entity), the UE 115 may proceed to turn on the UE-MR 405. At 460, based on turning on the UE-MR 405, the UE 115 may, via the UE-MR 405, transmit the first WUS to the network entity 105, indicating for the network entity 105 to wake-up the NW-MR 415 and initiate the initial access procedure with the UE 115. Based on transmitting the first WUS, the UE 115 may proceed to perform the operations at 470. Accordingly, at 465, the network entity 105 may monitor for the first WUS from the UE 115, where, if the network entity 105 detects the first WUS, the network entity may proceed to perform the operations at 470. Alternatively, if the network entity 105 does not detect the first WUS at 465 (due to the transmission of the first WUS not occurring), the network entity 105 may continue to operate in the low power mode and monitor for the first WUS from the UE 115.

At 472, based on detecting the first WUS, the network entity 105 may turn on the NW-MR 415. Similarly, at 470, based on transmitting the first WUS, the UE 115 may turn off the UE-MR 405 and turn on the UE-WUR 410. Accordingly, at 475 and based on turning on the NW-MR 415, the network entity 105 may transmit a second WUS. At 480, the UE 115 may monitor for the second WUS, where the second WUS may acknowledge the detection and reception of the first WUS at 465 and indicate that the NW-MR 415 is on and the network entity 105 is operating in the active mode. Additionally, the second WUS may trigger the UE to turn on the UE-MR 405 to receive paging indications, resume SSB and SIB1 transmission monitoring, or both. Accordingly, if the UE 115 does not detect the WUS at 480, indicating that the network entity 105 has yet to wake-up and transmit the second WUS, the UE 115 may continue to monitor for the second WUS at 480. At 482, the network entity 105 may turn off the NW-WUR 420. In some cases, the network entity 105 may turn off the NW-WUR 420 based on turning on the NW-MR at 472. Additionally, or alternatively, the network entity 105 may turn off the NW-WUR 420 based on transmitting the second WUS at 475.

At 485, based on receiving the second WUS, the UE 115 may turn on the UE-MR 405 to perform SSB searching. For example, at 490, based on transmitting the second WUS, the network entity 105 may transmit control signaling (e.g., SSBs), such that the UE 115 may search for and receive the SSB, where the SSB may provide information to the UE 115 associated with gaining access to the network entity 105.

FIGS. 5A and 5B show examples of a timing diagram 500 and a timing diagram 501, respectively, that support network energy savings in accordance with one or more aspects of the present disclosure. The timing diagram 500 and the timing diagram 501 may implement or be implemented to realize aspects of the wireless communications system 100, the wireless communications system 200, the flow diagram 300, and the flow diagram 400. For example, the timing diagram 500 and the timing diagram 501 may illustrate timing offsets between a LP-SS occasion 505 and a SSB occasion 510 communication between a UE 115 and a network entity 105, which may be examples of corresponding devices described herein, including with reference to FIGS. 1-4.

In some implementations of the techniques described herein, an association between an LP-SS occasion 505 (e.g., second signal occasion, second operating mode signal occasion) and an SSB occasion 510 (e.g., control signaling occasion) may be defined. In some examples, the UE 115—and the network entity 105 may utilize the association between the LP-SS occasions 505 and the SSB occasion 510 during initial access procedures for the UE 115, such as those described with respect to FIG. 4. For example, the UE may use the association between the LP-SS occasion 505 and the SSB occasion 510 to determine when to monitor for the SSB occasion 510. Such an association may reduce SSB search complexity for the UE 115 (e.g., using the UE-MR) in response to performing a LP-SS search (using a UE-WUR). As described herein, the association between the SSB occasions 510 and the LP-SS occasions 505 may be related to a periodicity 515 (e.g., T) of the LP-SS occasions 505 and the SSB occasions 510, and, additionally, or alternatively, timing offset(s) between the LP-SS occasions 505 and the SSB occasions 510.

With respect to the timing diagram 500, the LP-SS occasions 505 and the SSB occasions 510 may have a same periodicity 515-a according to a fixed time offset 520-a. Accordingly, in response to receiving an LP-SS in the LP-SS occasion 505-a, the UE 115 may determine the SSB occasion 510-a according to the offset 520-a based on the periodicity 515-a. Based on determining the SSB occasion 510-a, the UE 115 may receive the SSB by monitoring the SSB occasion 510-a.

With respect to the timing diagram 501, the LP-SS occasions 505 and the SSB occasions may have a different periodicity (e.g., multiple times) with a fixed timing offset 520. In a first example, a periodicity of the LP-SS occasions 505-b may be a multiple of a periodicity of the SSB occasion 510-b with a fixed timing offset 520-b, such that a quantity of the LP-SS occasions 505-b may be a multiple of the quantity of SSB occasions 510-b. In a second example, the periodicity of the SSB occasion 510-c may be a multiple of the periodicity of the LP-SS occasion 505-c according to a fixed timing offset 520-c, such that a quantity of the SSB occasions 510-c may be a multiple of the quantity of LP-SS occasions 505-c. In such examples, in response to receiving an LP-SS in the LP-SS occasion 505, the UE 115 may determine the SSB occasion 510 according to the offset 520. Based on determining the SSB occasion 510-a, the UE 115 may receive the SSB by monitoring the associated SSB occasion 510-a.

FIG. 6 shows an example of a process flow 600 that supports network energy savings in accordance with one or more aspects of the present disclosure. The process flow 600 may implement, or be implemented to, realize aspects of the wireless communications system 100, the wireless communications system 200, the flow diagram 300, the flow diagram 400, the timing diagram 500, and the timing diagram 501. For example, the process flow 600 illustrates communication between a UE 115-b and a network entity 105-b, which may be examples of corresponding devices described herein, including with reference to FIGS. 1-5B. The process flow 600 may provide for network energy savings through signaling between the network entity 105-b and the UE 115-b to support a low power mode using a WUR at the network entity 105-b. In some implementations, operations in process flow 600 marked with dashed lines may be optional or may be associated with specific states or scenarios.

At 605, in some implementations, the UE 115-b may be operating in a low power mode (e.g., second mode of operation) such that a first radio at the UE 115-b (e.g., UE-WUR) is on while a second radio at the UE 115-b (e.g., UE-MR) is off. In such examples, the first radio of the UE 115-b may be associated with lower power consumption relative to the second radio of the UE 115-b.

At 610, in some examples, the network entity 105-b may be operating in a first mode of operation at the network entity 105-b (e.g., normal power mode) such that a first radio at the network entity 105-b (e.g., NW-MR) is on, while a second radio at the network entity 105-b (e.g., NW-WUR) is off. For example, in some cases, the first radio of the network entity 105-b may be associated with the first mode of operation (e.g., active mode) at the network entity 105-b and the second radio of the network entity may be associated with a second mode of operation at the network entity 105-b (e.g., low power mode). The first mode of operation at the network entity 105-b may be associated with higher power consumption relative to the second mode of operation at the network entity 105-b.

At 615, in some implementations, the UE 115-b may receive, via the first radio of the UE 115-b, an operating mode signal (e.g., second signal or LP-SS 210) that may indicate whether the network entity 105-b is operating according to the first mode of operation or the second mode of operation. In some cases, the operating mode signal (e.g., LP-SS) may include a first sequence that indicates that the network entity 105-b is operating according to the first mode of operation. The network entity 105-b may transmit the operating mode signal using the first radio at the network entity 105-b.

At 620, in some examples, the network entity 105-b may determine there may be no active UEs 115 in communication with the network entity 105-b. In this case, the transmission of the second operating mode signal by the network entity 105-b, as described further at 635, may be based on the determination that there may be no active UEs 115 communicating with the network entity 105-b.

At 625, in some implementations, the network entity 105-b may determine to operate in the second operating mode (e.g., low power mode) such that the second radio at the network entity 105-b may be on while the first radio at the network entity 105-b may be off (except for transmission of a second operating mode signal and a first signal, as described further at 635 and 640). That is, the network entity 105-b may switch operating modes. In the second operating mode at the network entity 105-b, the network entity 105-b may use the first radio at the network entity 105-b to transmit LP-SS, LP-WUS, and LP-SIB1, as described herein with reference to FIG. 2. The network entity 105-b may use the second radio at the network entity 105-b to monitor for a first WUS (e.g., msg1-WUS, uplink WUS) from the UE 115-b, or from any active UE 115 in a cell.

At 630, in some implementations, the network entity 105-b may transmit, via the first radio and prior to turning off the first radio, a second operating mode signal (e.g., second signal, LP-SS, a LP-SIB, or WUS 235, as described herein with reference to FIG. 2) that indicates whether the network entity is operating according to the first mode of operation or the second mode of operation. In some implementations, the second operating mode signal (e.g., SP-SS) may include a second sequence that indicates that the network entity 105-b is operating according to the second mode of operation (e.g., low power mode). In other examples, the second operating mode signal may include an LP-WUS. In other examples, the second operating mode signal may include an LP-SIB.

At 635 the network entity 105-b may transmit, via the first radio and prior to turning off the first radio, a first signal that may indicate one or more resource occasions for transmission of a first WUS (e.g., uplink WUS, msg1-WUS). In some examples, the first signal may be an LP-SIB. In some cases, the first signal may include an on-off keying waveform, a frequency-shift keying waveform, or a frequency-modulated continuous wave waveform. In some implementations, the first signal may be transmitted subsequent to the second operating mode signal (e.g., second signal), as described at 630, according to a time offset. In some cases, the first signal may use various methods and definitions to indicate the one or more resource occasions (e.g., an index, such as a subframe index).

At 640, in some implementations, the UE 115-b may monitor for low power signaling, such as the second operating mode signal or the first signal, as described at 630 and 6435, respectively, (e.g., LP-SS, LP-WUS, and LP-SIB). In some cases, a UE 115-b may not monitor for low power signaling unless the UE 115-b has a message to transmit to the network entity 105-b. In other examples, the UE 115-b may perform initial access procedures and may monitor for the first signal, as described herein with reference to FIGS. 3 and 4.

At 650, the UE 115-b may transmit, via the second radio of the UE 115-b and the one or more resource occasions, the first WUS, where the first WUS indicates for the network entity 105-b to operate according to the first mode of operation, where the first mode of operation is associated with higher power consumption relative to the second mode of operation. In some cases, the first WUS may include an on-off keying waveform, a frequency-shift keying waveform, or a frequency-modulated continuous wave waveform. For example, the first WUS may use OFDM signals.

In some implementations, the network entity 105-b may not rely on knowledge of which UE 115 transmitted the first WUS. That is, the network entity 105-b may receive the first WUS to transition to the first mode of operation at the network entity 105-b and may not rely on knowledge of which UE 115 or the quantity of UEs 115 that may transmit the first WUS (e.g., the network entity 105-b may be unaware of conflict for the UE 115-b or UEs 115). Accordingly, because the network entity 105-b may not rely on the knowledge of which UE 115 transmitted the first WUS, the first WUS may include a single universal format (e.g., a format not particular to the UE 115-b, in contrast to a RACH msg1, which may use many formats).

At 655, the network entity 105-b may monitor for a first WUS from the UE 115-b. The network entity 105-b may monitor for the first WUS using the second radio at the network entity 105-b (e.g., in the second mode of operation, in the low power mode).

At 660, the UE 115-b may receive, based on the transmission of the first WUS, a second WUS (e.g., LP-WUS, downlink WUS) that may indicate for the UE 115-b to operate via the second radio at the UE 115-b (e.g., UE-MR). That is, a network entity 105-b may transmit, via the first radio at the network entity 105-b and based on the reception of the first WUS, the second WUS, where the second WUS may confirm or acknowledge receipt of the first WUS at the network entity 105-b and indicate for the UE 115-b to monitor for control signaling.

At 665, the network entity 105-b may transmit, via the first radio of the network entity 105-b, control signaling based on the reception of the first WUS. For example, the network entity 105-b may resume transmission of SSBs and SIB1s.

At 670, the UE 115-b may monitor, via the second radio of the UE 115-b, for the control signaling based on the transmission of the first WUS. In some cases, the control signaling may include an SSB. The UE 115-b may monitor for the control signaling in accordance with a time offset between a resource of the second operating mode signal, as described at 630, and a resource of the control signaling, as described with respect to FIGS. 5A and 5B. In some cases, the control signaling may be transmitted with some periodicity. In some examples, the periodicity of the control signaling may be the same as the periodicity of the second operating mode signal, as described at 630. That is, a periodicity of the second operating mode signal may be equivalent to a periodicity of the control signaling. The time offset may be based on the equivalent periodicities of the second operating mode signal and the control signaling. In other examples, the periodicity of the control signaling may be a multiple of the periodicity of the second operating mode signal or the periodicity of the second signal may be a multiple of the periodicity of the control signaling. The time offset may be based on the relationship between the periodicity of the control signaling and the periodicity of the second operating mode signal.

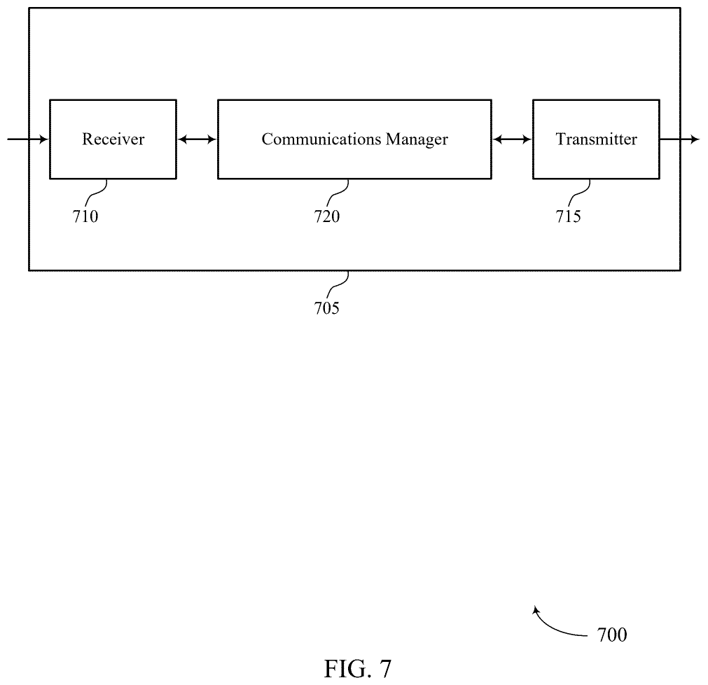

FIG. 7 shows a block diagram 700 of a device 705 that supports network energy savings in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to network energy savings). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to network energy savings). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of network energy savings as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving, via a first radio of the UE, a first signal that indicates one or more resource occasions for transmission of a first WUS. The communications manager 720 is capable of, configured to, or operable to support a means for transmitting, via a second radio of the UE and the one or more resource occasions, the first WUS, where the first WUS indicates for a network entity to operate according to a first mode of operation, where the first mode of operation is associated with higher power consumption relative to a second mode of operation. The communications manager 720 is capable of, configured to, or operable to support a means for monitoring, via the second radio, for control signaling based on the transmission of the first WUS.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

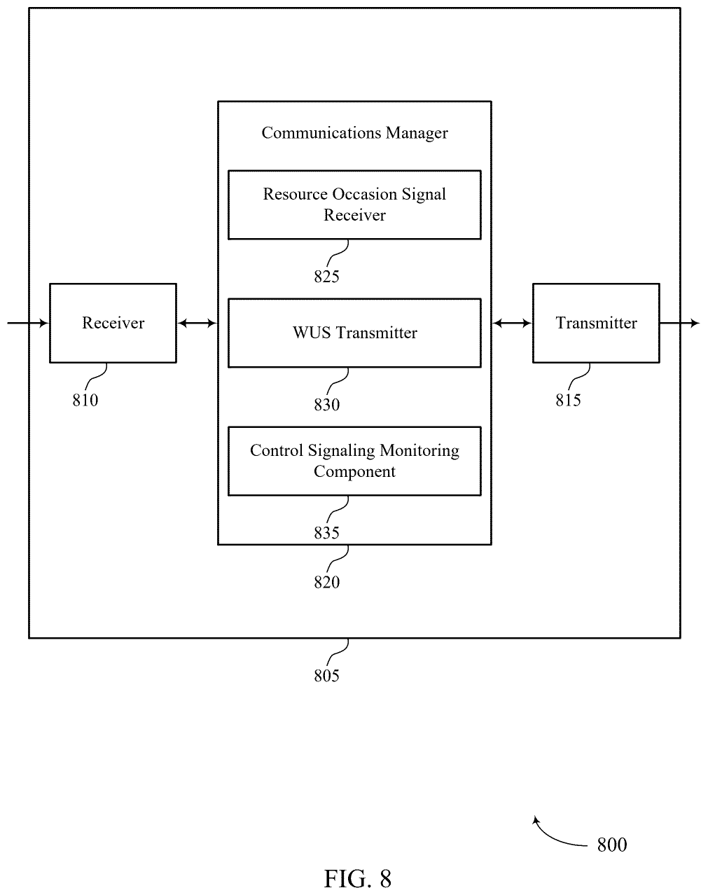

FIG. 8 shows a block diagram 800 of a device 805 that supports network energy savings in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to network energy savings). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to network energy savings). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of network energy savings as described herein. For example, the communications manager 820 may include a resource occasion signal receiver 825, a WUS transmitter 830, a control signaling monitoring component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The resource occasion signal receiver 825 is capable of, configured to, or operable to support a means for receiving, via a first radio of the UE, a first signal that indicates one or more resource occasions for transmission of a first WUS. The WUS transmitter 830 is capable of, configured to, or operable to support a means for transmitting, via a second radio of the UE and the one or more resource occasions, the first WUS, where the first WUS indicates for a network entity to operate according to a first mode of operation, where the first mode of operation is associated with higher power consumption relative to a second mode of operation. The control signaling monitoring component 835 is capable of, configured to, or operable to support a means for monitoring, via the second radio, for control signaling based on the transmission of the first WUS.

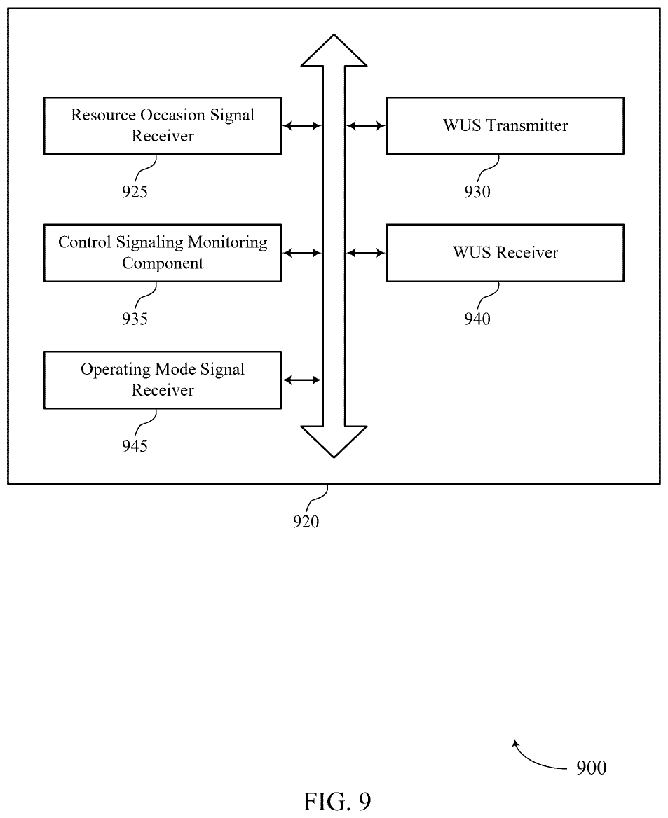

FIG. 9 shows a block diagram 900 of a communications manager 920 that supports network energy savings in accordance with one or more aspects of the present disclosure. The communications manager 920 may be an example of aspects of a communications manager 720, a communications manager 820, or both, as described herein. The communications manager 920, or various components thereof, may be an example of means for performing various aspects of network energy savings as described herein. For example, the communications manager 920 may include a resource occasion signal receiver 925, a WUS transmitter 930, a control signaling monitoring component 935, a WUS receiver 940, an operating mode signal receiver 945, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The resource occasion signal receiver 925 is capable of, configured to, or operable to support a means for receiving, via a first radio of the UE, a first signal that indicates one or more resource occasions for transmission of a first WUS. The WUS transmitter 930 is capable of, configured to, or operable to support a means for transmitting, via a second radio of the UE and the one or more resource occasions, the first WUS, where the first WUS indicates for a network entity to operate according to a first mode of operation, where the first mode of operation is associated with higher power consumption relative to a second mode of operation. The control signaling monitoring component 935 is capable of, configured to, or operable to support a means for monitoring, via the second radio, for control signaling based on the transmission of the first WUS.

In some examples, the WUS receiver 940 is capable of, configured to, or operable to support a means for receiving, via the first radio and based on the transmission of the first WUS, a second WUS that indicates for the UE to operate via the first radio, where the control signaling is monitored further based on reception of the second WUS.

In some examples, the operating mode signal receiver 945 is capable of, configured to, or operable to support a means for receiving, via the first radio of the UE, a second signal that indicates whether the network entity is operating according to the first mode of operation or the second mode of operation.

In some examples, the second signal includes a first sequence that indicates that the network entity is operating according to the first mode of operation.

In some examples, the second signal includes a second sequence that indicates that the network entity is operating according to the second mode of operation.

In some examples, the second signal includes a LP-SS and the control signaling includes a SSB, and the control signaling is monitored in accordance with a time offset between a resource of the second signal and a resource of the control signaling.

In some examples, a periodicity of the second signal is equivalent to a periodicity of the control signaling.

In some examples, a periodicity of the control signaling is a multiple of a periodicity of the second signal or the periodicity of the second signal is a multiple of the periodicity of the control signaling.

In some examples, the second signal is a LP-SS and the first signal is a LP-SIB, and the first signal is received subsequent to the second signal according to a time offset.

In some examples, the second signal includes a second WUS and the first signal includes a LP-SIB.

In some examples, the first signal and the second signal include a LP-SIB.

In some examples, the first radio of the UE is associated with lower power consumption relative to the second radio of the UE.

In some examples, the first WUS includes an on-off keying waveform, a frequency-shift keying waveform, or a frequency-modulated continuous wave waveform.

In some examples, the first signal includes an on-off keying waveform, a frequency-shift keying waveform, or a frequency-modulated continuous wave waveform.

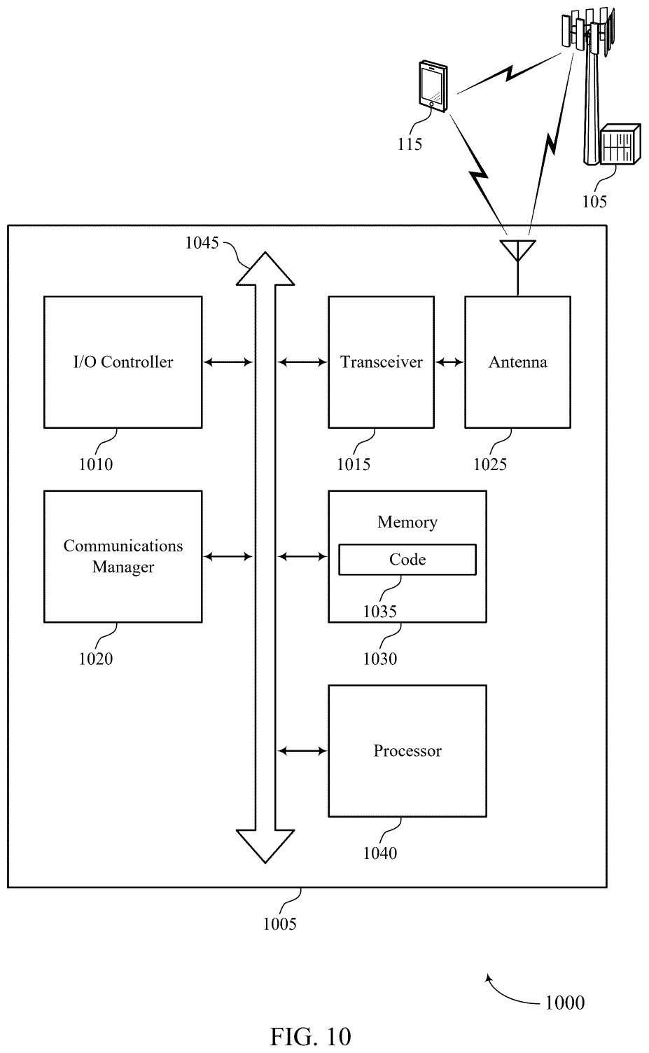

FIG. 10 shows a diagram of a system 1000 including a device 1005 that supports network energy savings in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting network energy savings). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving, via a first radio of the UE, a first signal that indicates one or more resource occasions for transmission of a first WUS. The communications manager 1020 is capable of, configured to, or operable to support a means for transmitting, via a second radio of the UE and the one or more resource occasions, the first WUS, where the first WUS indicates for a network entity to operate according to a first mode of operation, where the first mode of operation is associated with higher power consumption relative to a second mode of operation. The communications manager 1020 is capable of, configured to, or operable to support a means for monitoring, via the second radio, for control signaling based on the transmission of the first WUS.

By including or configuring the communications manager 1020 in accordance with examples as described herein, the device 1005 may support techniques for reduced latency, reduced power consumption, more efficient utilization of communication resources, improved coordination between devices, and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of network energy savings as described herein, or the at least one processor 1040 and the at least one memory 1030 may be otherwise configured to, individually or collectively, perform or support such operations.

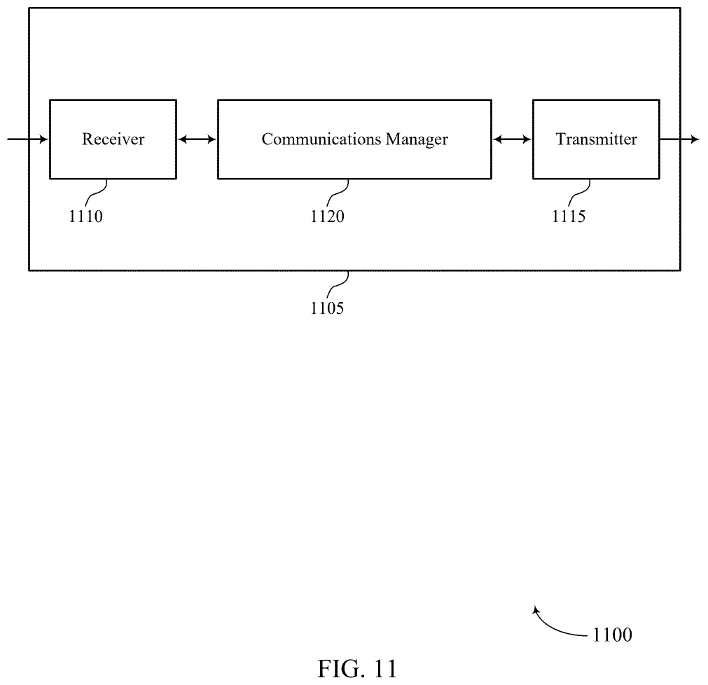

FIG. 11 shows a block diagram 1100 of a device 1105 that supports network energy savings in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of network energy savings as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting, via a first radio of the network entity, a first signal that indicates one or more resource occasions for a first WUS. The communications manager 1120 is capable of, configured to, or operable to support a means for receiving, via a second radio of the network entity and the one or more resource occasions, the first WUS, where the first WUS indicates for the network entity to operate according to a first mode of operation, where the first mode of operation is associated with higher power consumption relative to a second mode of operation. The communications manager 1120 is capable of, configured to, or operable to support a means for transmitting, via the first radio, control signaling based on the reception of the first WUS.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

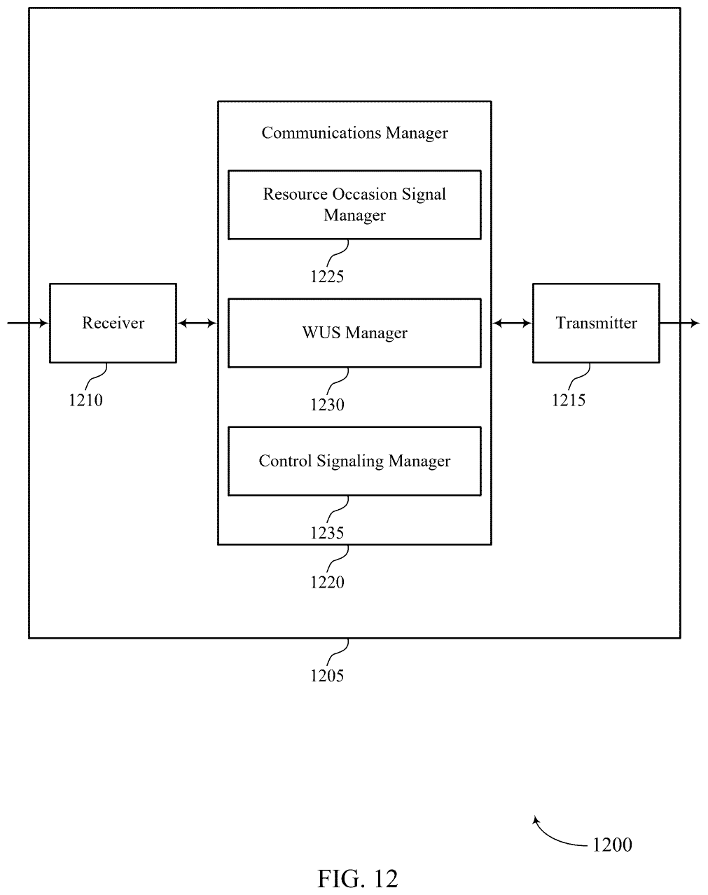

FIG. 12 shows a block diagram 1200 of a device 1205 that supports network energy savings in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of network energy savings as described herein. For example, the communications manager 1220 may include a resource occasion signal manager 1225, a WUS manager 1230, a control signaling manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The resource occasion signal manager 1225 is capable of, configured to, or operable to support a means for transmitting, via a first radio of the network entity, a first signal that indicates one or more resource occasions for a first WUS. The WUS manager 1230 is capable of, configured to, or operable to support a means for receiving, via a second radio of the network entity and the one or more resource occasions, the first WUS, where the first WUS indicates for the network entity to operate according to a first mode of operation, where the first mode of operation is associated with higher power consumption relative to a second mode of operation. The control signaling manager 1235 is capable of, configured to, or operable to support a means for transmitting, via the first radio, control signaling based on the reception of the first WUS.

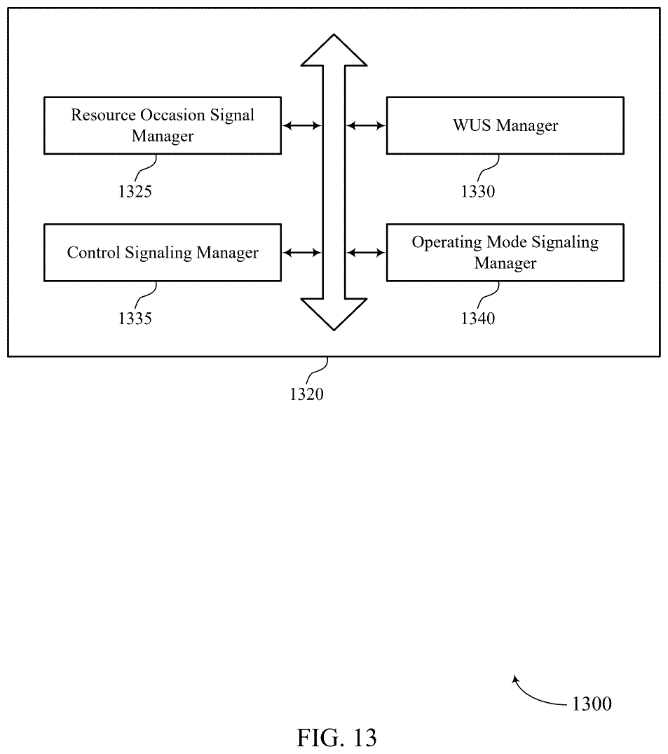

FIG. 13 shows a block diagram 1300 of a communications manager 1320 that supports network energy savings in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of network energy savings as described herein. For example, the communications manager 1320 may include a resource occasion signal manager 1325, a WUS manager 1330, a control signaling manager 1335, an operating mode signaling manager 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The resource occasion signal manager 1325 is capable of, configured to, or operable to support a means for transmitting, via a first radio of the network entity, a first signal that indicates one or more resource occasions for a first WUS. The WUS manager 1330 is capable of, configured to, or operable to support a means for receiving, via a second radio of the network entity and the one or more resource occasions, the first WUS, where the first WUS indicates for the network entity to operate according to a first mode of operation, where the first mode of operation is associated with higher power consumption relative to a second mode of operation. The control signaling manager 1335 is capable of, configured to, or operable to support a means for transmitting, via the first radio, control signaling based on the reception of the first WUS.

In some examples, the WUS manager 1330 is capable of, configured to, or operable to support a means for transmitting, via the first radio and based on reception of the first WUS, a second WUS that indicates an acknowledgement of the first WUS, where the control signaling is transmitted based on transmission of the second WUS.

In some examples, the operating mode signaling manager 1340 is capable of, configured to, or operable to support a means for transmitting, via the first radio, a second signal that indicates whether the network entity is operating according to the first mode of operation or the second mode of operation.

In some examples, the second signal includes a first sequence that indicates that the network entity is operating according to the first mode of operation.

In some examples, the second signal includes a second sequence that indicates that the network entity is operating according to the second mode of operation.

In some examples, the transmission of the second signal is based on a determination that there are no active user equipments (UEs) communicating with the network entity.

In some examples, the second signal includes a LP-SS and the control signaling includes a SSB, and the control signaling is transmitted in accordance with a time offset between a resource of the second signal and a resource of the control signaling.

In some examples, a periodicity of the second signal is equivalent to a periodicity of the control signaling.

In some examples, a periodicity of the control signaling is a multiple of a periodicity of the first signal or the periodicity of the first signal is a multiple of the periodicity of the control signaling.

In some examples, the second signal is a LP-SS and the first signal is a LP-SIB, and the first signal is transmitted subsequent to the second signal according to a time offset.

In some examples, the second signal includes a second WUS and the first signal includes a LP-SIB.

In some examples, the first signal and the second signal include a LP-SIB.

In some examples, the first radio of the network entity is associated with the first mode of operation and the second radio of the network entity is associated with the second mode of operation.

In some examples, the first WUS includes an on-off keying waveform, a frequency-shift keying waveform, or a frequency-modulated continuous wave waveform.

In some examples, the first signal includes an on-off keying waveform, a frequency-shift keying waveform, or a frequency-modulated continuous wave waveform.

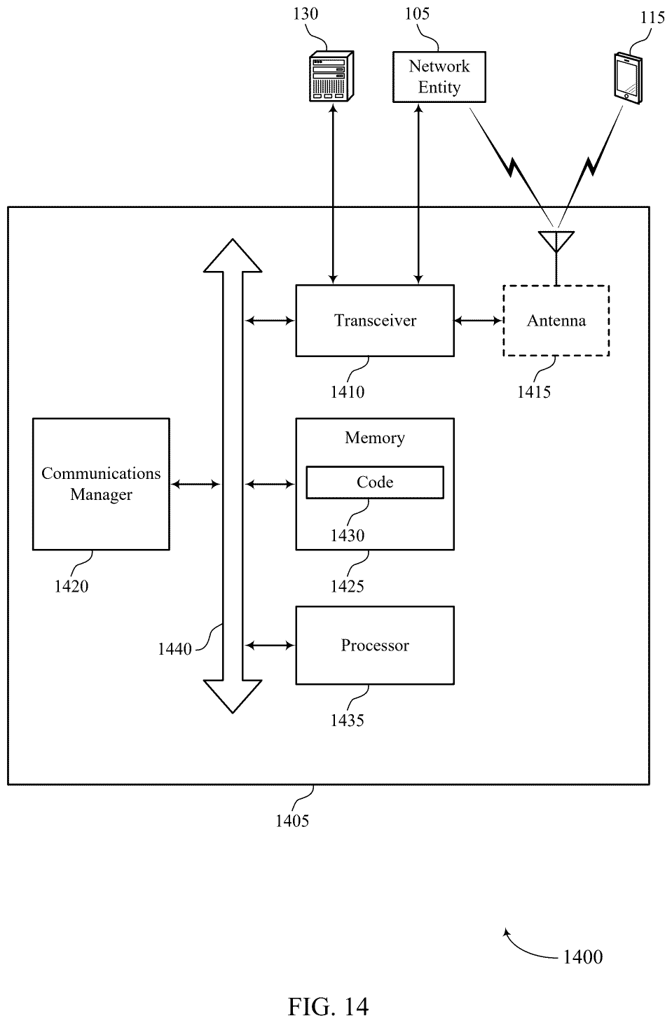

FIG. 14 shows a diagram of a system 1400 including a device 1405 that supports network energy savings in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting network energy savings). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for transmitting, via a first radio of the network entity, a first signal that indicates one or more resource occasions for a first WUS. The communications manager 1420 is capable of, configured to, or operable to support a means for receiving, via a second radio of the network entity and the one or more resource occasions, the first WUS, where the first WUS indicates for the network entity to operate according to a first mode of operation, where the first mode of operation is associated with higher power consumption relative to a second mode of operation. The communications manager 1420 is capable of, configured to, or operable to support a means for transmitting, via the first radio, control signaling based on the reception of the first WUS.

By including or configuring the communications manager 1420 in accordance with examples as described herein, the device 1405 may support techniques for reduced latency, reduced power consumption, more efficient utilization of communication resources, improved coordination between devices, and longer battery life.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of network energy savings as described herein, or the at least one processor 1435 and the at least one memory 1425 may be otherwise configured to, individually or collectively, perform or support such operations.

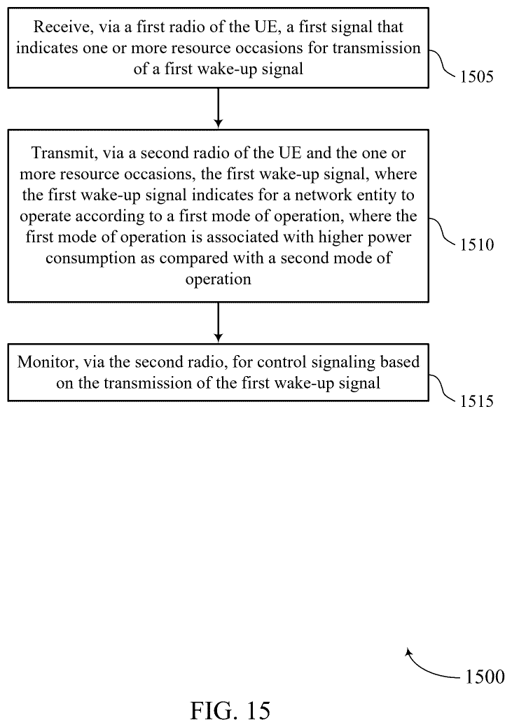

FIG. 15 shows a flowchart illustrating a method 1500 that supports network energy savings in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, via a first radio of the UE, a first signal that indicates one or more resource occasions for transmission of a first WUS. The operations of 1505 may be performed in accordance with examples as disclosed herein. In some examples, aspects of the operations of 1505 may be performed by a resource occasion signal receiver 925 as described with reference to FIG. 9.

At 1510, the method may include transmitting, via a second radio of the UE and the one or more resource occasions, the first WUS, where the first WUS indicates for a network entity to operate according to a first mode of operation, where the first mode of operation is associated with higher power consumption relative to a second mode of operation. The operations of 1510 may be performed in accordance with examples as disclosed herein. In some examples, aspects of the operations of 1510 may be performed by a WUS transmitter 930 as described with reference to FIG. 9.

At 1515, the method may include monitoring, via the second radio, for control signaling based on the transmission of the first WUS. The operations of 1515 may be performed in accordance with examples as disclosed herein. In some examples, aspects of the operations of 1515 may be performed by a control signaling monitoring component 935 as described with reference to FIG. 9.

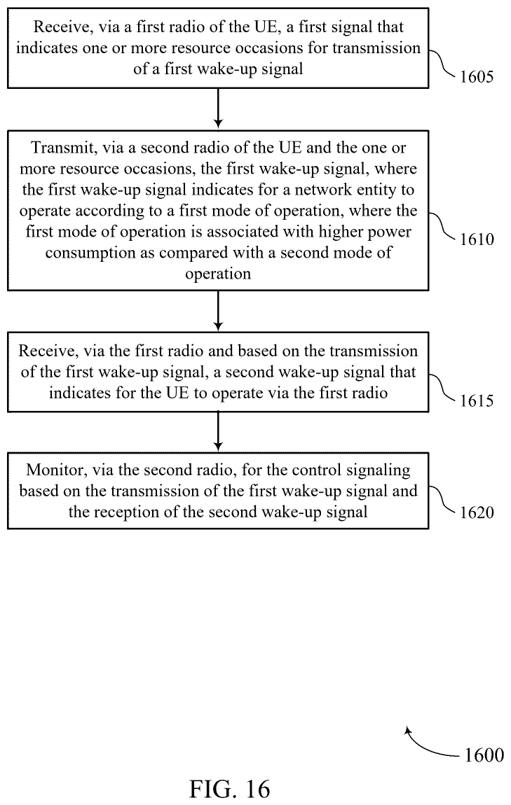

FIG. 16 shows a flowchart illustrating a method 1600 that supports network energy savings in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, via a first radio of the UE, a first signal that indicates one or more resource occasions for transmission of a first WUS. The operations of 1605 may be performed in accordance with examples as disclosed herein. In some examples, aspects of the operations of 1605 may be performed by a resource occasion signal receiver 925 as described with reference to FIG. 9.

At 1610, the method may include transmitting, via a second radio of the UE and the one or more resource occasions, the first WUS, where the first WUS indicates for a network entity to operate according to a first mode of operation, where the first mode of operation is associated with higher power consumption relative to a second mode of operation. The operations of 1610 may be performed in accordance with examples as disclosed herein. In some examples, aspects of the operations of 1610 may be performed by a WUS transmitter 930 as described with reference to FIG. 9.

At 1615, the method may include receiving, via the first radio and based on the transmission of the first WUS, a second WUS that indicates for the UE to operate via the first radio. The operations of 1615 may be performed in accordance with examples as disclosed herein. In some examples, aspects of the operations of 1615 may be performed by a WUS receiver 940 as described with reference to FIG. 9.

At 1620, the method may include monitoring, via the second radio, for the control signaling based on the transmission of the first WUS and the reception of the second WUS. The operations of 1620 may be performed in accordance with examples as disclosed herein. In some examples, aspects of the operations of 1620 may be performed by a control signaling monitoring component 935 as described with reference to FIG. 9.

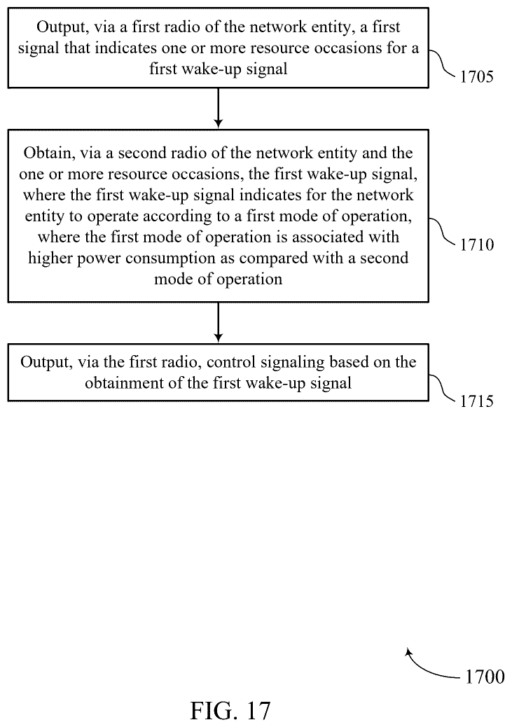

FIG. 17 shows a flowchart illustrating a method 1700 that supports network energy savings in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, via a first radio of the network entity, a first signal that indicates one or more resource occasions for a first WUS. The operations of 1705 may be performed in accordance with examples as disclosed herein. In some examples, aspects of the operations of 1705 may be performed by a resource occasion signal manager 1325 as described with reference to FIG. 13.

At 1710, the method may include receiving, via a second radio of the network entity and the one or more resource occasions, the first WUS, where the first WUS indicates for the network entity to operate according to a first mode of operation, where the first mode of operation is associated with higher power consumption relative to a second mode of operation. The operations of 1710 may be performed in accordance with examples as disclosed herein. In some examples, aspects of the operations of 1710 may be performed by a WUS manager 1330 as described with reference to FIG. 13.

At 1715, the method may include transmitting, via the first radio, control signaling based on the reception of the first WUS. The operations of 1715 may be performed in accordance with examples as disclosed herein. In some examples, aspects of the operations of 1715 may be performed by a control signaling manager 1335 as described with reference to FIG. 13.

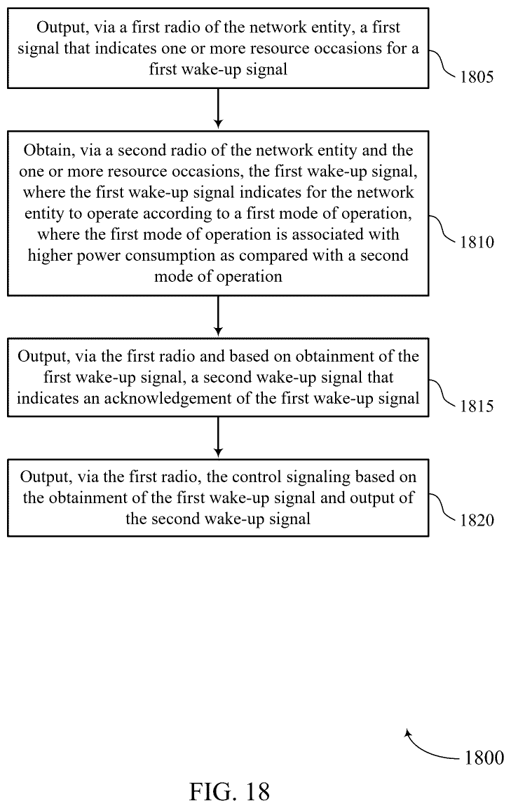

FIG. 18 shows a flowchart illustrating a method 1800 that supports network energy savings in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, via a first radio of the network entity, a first signal that indicates one or more resource occasions for a first WUS. The operations of 1805 may be performed in accordance with examples as disclosed herein. In some examples, aspects of the operations of 1805 may be performed by a resource occasion signal manager 1325 as described with reference to FIG. 13.

At 1810, the method may include receiving, via a second radio of the network entity and the one or more resource occasions, the first WUS, where the first WUS indicates for the network entity to operate according to a first mode of operation, where the first mode of operation is associated with higher power consumption relative to a second mode of operation. The operations of 1810 may be performed in accordance with examples as disclosed herein. In some examples, aspects of the operations of 1810 may be performed by a WUS manager 1330 as described with reference to FIG. 13.

At 1815, the method may include transmitting, via the first radio and based on reception of the first WUS, a second WUS that indicates an acknowledgement of the first WUS. The operations of 1815 may be performed in accordance with examples as disclosed herein. In some examples, aspects of the operations of 1815 may be performed by a WUS manager 1330 as described with reference to FIG. 13.

At 1820, the method may include transmitting, via the first radio, the control signaling based on the reception of the first WUS and transmission of the send WUS. The operations of 1820 may be performed in accordance with examples as disclosed herein. In some examples, aspects of the operations of 1820 may be performed by a control signaling manager 1335 as described with reference to FIG. 13.

The following provides an overview of aspects of the present disclosure:
Aspect 1: A method for wireless communication at a UE, comprising: receiving, via a first radio of the UE, a first signal that indicates one or more resource occasions for transmission of a first WUS; transmitting, via a second radio of the UE and the one or more resource occasions, the first WUS, wherein the first WUS indicates for a network entity to operate according to a first mode of operation, wherein the first mode of operation is associated with higher power consumption relative to a second mode of operation; and monitoring, via the second radio, for control signaling based at least in part on the transmission of the first WUS.
Aspect 2: The method of aspect 1, further comprising: receiving, via the first radio and based at least in part on the transmission of the first WUS, a second WUS that indicates for the UE to operate via the first radio, wherein the control signaling is monitored further based at least in part on reception of the second WUS.
Aspect 3: The method of any of aspects 1 through 2, further comprising: receiving, via the first radio of the UE, a second signal that indicates whether the network entity is operating according to the first mode of operation or the second mode of operation.
Aspect 4: The method of aspect 3, wherein the second signal comprises a first sequence that indicates that the network entity is operating according to the first mode of operation.
Aspect 5: The method of any of aspects 3 through 4, wherein the second signal comprises a second sequence that indicates that the network entity is operating according to the second mode of operation.
Aspect 6: The method of any of aspects 3 through 5, wherein the second signal comprises a LP-SS and the control signaling comprises a SSB, and wherein the control signaling is monitored in accordance with a time offset between a resource of the second signal and a resource of the control signaling.
Aspect 7: The method of aspect 6, wherein a periodicity of the second signal is equivalent to a periodicity of the control signaling.
Aspect 8: The method of any of aspects 6 through 7, wherein a periodicity of the control signaling is a multiple of a periodicity of the second signal or the periodicity of the second signal is a multiple of the periodicity of the control signaling.
Aspect 9: The method of any of aspects 3 through 8, wherein the second signal is a LP-SS and the first signal is a LP-SIB, and wherein the first signal is received subsequent to the second signal according to a time offset.
Aspect 10: The method of any of aspects 3 through 9, wherein the second signal comprises a second WUS and the first signal comprises a LP-SIB.

Aspect 11: The method of any of aspects 3 through 10, wherein the first signal and the second signal comprise a LP-SIB.
Aspect 12: The method of any of aspects 1 through 11, wherein the first radio of the UE is associated with lower power consumption relative to the second radio of the UE.
Aspect 13: The method of any of aspects 1 through 12, wherein the first WUS comprises an on-off keying waveform, a frequency-shift keying waveform, or a frequency-modulated continuous wave waveform.
Aspect 14: The method of any of aspects 1 through 13, wherein the first signal comprises an on-off keying waveform, a frequency-shift keying waveform, or a frequency-modulated continuous wave waveform.
Aspect 15: A method for wireless communication at a network entity, comprising: transmitting, via a first radio of the network entity, a first signal that indicates one or more resource occasions for a first WUS; receiving, via a second radio of the network entity and the one or more resource occasions, the first WUS, wherein the first WUS indicates for the network entity to operate according to a first mode of operation, wherein the first mode of operation is associated with higher power consumption relative to a second mode of operation; and transmitting, via the first radio, control signaling based at least in part on the reception of the first WUS.
Aspect 16: The method of aspect 15, further comprising: transmitting, via the first radio and based at least in part on reception of the first WUS, a second WUS that indicates an acknowledgement of the first WUS, wherein the control signaling is transmitted based at least in part on transmission of the second WUS.
Aspect 17: The method of any of aspects 15 through 16, further comprising: transmitting, via the first radio, a second signal that indicates whether the network entity is operating according to the first mode of operation or the second mode of operation.
Aspect 18: The method of aspect 17, wherein the second signal comprises a first sequence that indicates that the network entity is operating according to the first mode of operation.
Aspect 19: The method of any of aspects 17 through 18, wherein the second signal comprises a second sequence that indicates that the network entity is operating according to the second mode of operation.
Aspect 20: The method of any of aspects 17 through 19, wherein the transmission of the second signal is based at least in part on a determination that there are no active user equipments (UEs) communicating with the network entity.
Aspect 21: The method of any of aspects 17 through 20, wherein the second signal comprises a LP-SS and the control signaling comprises a SSB, and the control signaling is transmitted in accordance with a time offset between a resource of the second signal and a resource of the control signaling.
Aspect 22: The method of aspect 21, wherein a periodicity of the second signal is equivalent to a periodicity of the control signaling.
Aspect 23: The method of any of aspects 21 through 22, wherein a periodicity of the control signaling is a multiple of a periodicity of the first signal or the periodicity of the first signal is a multiple of the periodicity of the control signaling.
Aspect 24: The method of any of aspects 17 through 23, wherein the second signal is a LP-SS and the first signal is a LP-SIB, and wherein the first signal is transmitted subsequent to the second signal according to a time offset.
Aspect 25: The method of any of aspects 17 through 24, wherein the second signal comprises a second WUS and the first signal comprises a LP-SIB.
Aspect 26: The method of any of aspects 17 through 25, wherein the first signal and the second signal comprise a LP-SIB.
Aspect 27: The method of any of aspects 15 through 26, wherein the first radio of the network entity is associated with the first mode of operation and the second radio of the network entity is associated with the second mode of operation.
Aspect 28: The method of any of aspects 15 through 27, wherein the first WUS comprises an on-off keying waveform, a frequency-shift keying waveform, or a frequency-modulated continuous wave waveform.
Aspect 29: The method of any of aspects 15 through 28, wherein the first signal comprises an on-off keying waveform, a frequency-shift keying waveform, or a frequency-modulated continuous wave waveform.
Aspect 30: A UE for wireless communication, comprising one or more memories storing processor-executable code, and one or more processors coupled with the one or more memories and individually or collectively operable to execute the code to cause the UE to perform a method of any of aspects 1 through 14.
Aspect 31: A UE for wireless communication, comprising at least one means for performing a method of any of aspects 1 through 14.
Aspect 32: A non-transitory computer-readable medium storing code for wireless communication, the code comprising instructions executable by one or more processors to perform a method of any of aspects 1 through 14.
Aspect 33: A network entity for wireless communication, comprising one or more memories storing processor-executable code, and one or more processors coupled with the one or more memories and individually or collectively operable to execute the code to cause the network entity to perform a method of any of aspects 15 through 29.
Aspect 34: A network entity for wireless communication, comprising at least one means for performing a method of any of aspects 15 through 29.
Aspect 35: A non-transitory computer-readable medium storing code for wireless communication, the code comprising instructions executable by one or more processors to perform a method of any of aspects 15 through 29. It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first radio of the UE, a first signal that indicates one or more resource occasions for transmission of a first wake-up signal;
transmit, via a second radio of the UE and the one or more resource occasions, the first wake-up signal, wherein the first wake-up signal indicates for a network entity to operate according to a first mode of operation, and wherein the first mode of operation is associated with higher power consumption relative to a second mode of operation; and
monitor, via the second radio, for control signaling based at least in part on the transmission of the first wake-up signal.

2. The UE of claim 1, wherein the one or more processors are individually or collectively further operable to execute the code to cause the UE to:
receive, via the first radio and based at least in part on the transmission of the first wake-up signal, a second wake-up signal that indicates for the UE to operate via the first radio, wherein the control signaling is monitored further based at least in part on reception of the second wake-up signal.

3. The UE of claim 1, wherein the one or more processors are individually or collectively further operable to execute the code to cause the UE to:
receive, via the first radio of the UE, a second signal that indicates whether the network entity operates according to the first mode of operation or the second mode of operation.

4. The UE of claim 3, wherein the second signal comprises a first sequence that indicates that the network entity operates according to the first mode of operation.

5. The UE of claim 3, wherein the second signal comprises a second sequence that indicates that the network entity operates according to the second mode of operation.

6. The UE of claim 3, wherein the second signal comprises a low power synchronization signal and the control signaling comprises a synchronization signal block, and wherein the control signaling is monitored in accordance with a time offset between a resource of the second signal and a resource of the control signaling.

7. The UE of claim 6, wherein a periodicity of the second signal is equivalent to a periodicity of the control signaling.

8. The UE of claim 6, wherein a periodicity of the control signaling is a multiple of a periodicity of the second signal, or the periodicity of the second signal is a multiple of the periodicity of the control signaling.

9. The UE of claim 3, wherein the second signal is a low power synchronization signal and the first signal is a low power system information block, and wherein the first signal is received subsequent to the second signal according to a time offset.

10. The UE of claim 3, wherein the second signal comprises a second wake-up signal and the first signal comprises a low power system information block.

11. The UE of claim 3, wherein the first signal and the second signal comprise a low power system information block.

12. The UE of claim 1, wherein the first radio of the UE is associated with lower power consumption relative to the second radio of the UE.

13. The UE of claim 1, wherein the first wake-up signal comprises an on-off keying waveform, a frequency-shift keying waveform, or a frequency-modulated continuous wave waveform.

14. The UE of claim 1, wherein the first signal comprises an on-off keying waveform, a frequency-shift keying waveform, or a frequency-modulated continuous wave waveform.

15. A network entity, comprising:
one or more memories storing processor-executable code; and
one or more processors coupled with the one or more memories and individually or collectively operable to execute the code to cause the network entity to:
transmit, via a first radio of the network entity, a first signal that indicates one or more resource occasions for a first wake-up signal;
receive, via a second radio of the network entity and the one or more resource occasions, the first wake-up signal, wherein the first wake-up signal indicates for the network entity to operate according to a first mode of operation, wherein the first mode of operation is associated with higher power consumption relative to a second mode of operation; and
transmit, via the first radio, control signaling based at least in part on the reception of the first wake-up signal.

16. The network entity of claim 15, wherein the one or more processors are individually or collectively further operable to execute the code to cause the network entity to:
transmit, via the first radio and based at least in part on the reception of the first wake-up signal, a second wake-up signal that indicates an acknowledgement of the first wake-up signal, wherein the control signaling is transmitted based at least in part on the transmission of the second wake-up signal.

17. The network entity of claim 15, wherein the one or more processors are individually or collectively further operable to execute the code to cause the network entity to:
transmit, via the first radio, a second signal that indicates whether the network entity operates according to the first mode of operation or the second mode of operation.

18. The network entity of claim 17, wherein the second signal comprises a first sequence that indicates that the network entity operates according to the first mode of operation.

19. The network entity of claim 17, wherein the second signal comprises a second sequence that indicates that the network entity operates according to the second mode of operation.

20. The network entity of claim 17, wherein the transmission of the second signal is based at least in part on a determination that there are no active user equipments (UEs) within a coverage area of the network entity.

21. The network entity of claim 17, wherein the second signal comprises a low power synchronization signal and the control signaling comprises a synchronization signal block, and wherein the control signaling is transmitted in accordance with a time offset between a resource of the second signal and a resource of the control signaling.

22. The network entity of claim 21, wherein a periodicity of the second signal is equivalent to a periodicity of the control signaling.

23. The network entity of claim 21, wherein a periodicity of the control signaling is a multiple of a periodicity of the first signal, or wherein the periodicity of the first signal is a multiple of the periodicity of the control signaling.

24. The network entity of claim 17, wherein the second signal is a low power synchronization signal and the first signal is a low power system information block, and wherein the first signal is transmitted subsequent to the second signal according to a time offset.

25. The network entity of claim 17, wherein the second signal comprises a second wake-up signal and the first signal comprises a low power system information block.

26. The network entity of claim 17, wherein the first signal and the second signal comprise a low power system information block.

27. The network entity of claim 15, wherein the first radio of the network entity is associated with the first mode of operation and the second radio of the network entity is associated with the second mode of operation.

28. The network entity of claim 15, wherein the first wake-up signal comprises an on-off keying waveform, a frequency-shift keying waveform, or a frequency-modulated continuous wave waveform.

29. A method for wireless communication at a user equipment (UE), comprising:
receiving, via a first radio of the UE, a first signal that indicates one or more resource occasions for transmission of a first wake-up signal;
transmitting, via a second radio of the UE and the one or more resource occasions, the first wake-up signal, wherein the first wake-up signal indicates for a network entity to operate according to a first mode of operation, wherein the first mode of operation is associated with higher power consumption relative to a second mode of operation; and
monitoring, via the second radio, for control signaling based at least in part on the transmission of the first wake-up signal.

30. A method for wireless communication at a network entity, comprising:
transmitting, via a first radio of the network entity, a first signal that indicates one or more resource occasions for a first wake-up signal;
receiving, via a second radio of the network entity and the one or more resource occasions, the first wake-up signal, wherein the first wake-up signal indicates for the network entity to operate according to a first mode of operation, wherein the first mode of operation is associated with higher power consumption relative to a second mode of operation; and
transmitting, via the first radio, control signaling based at least in part on the reception of the first wake-up signal.
